(19) United States
(12) Patent Application Publication
(10) Pub. No.: US 2026/0129150 A1
(43) Pub. Date: May 7, 2026

(54) GENERATING ALTERNATIVE IMAGE VIEWS FROM STEREO DISPARITY DATA

(71) Applicant: Nvidia Corporation, Santa Clara, CA (US)

(72) Inventors: Branislav Kisacanin, Plano, TX (US); Ching-Yu Hung, Cupertino, CA (US)

(21) Appl. No.: 18/937,713

(22) Filed: Nov. 5, 2024

(51) Int. Cl. H04N 13/117; G06T 5/20; G06T 7/50; H04N 13/00

(52) U.S. Cl. CPC H04N 13/117; G06T 5/20; G06T 7/50; H04N 2013/0081

(57) ABSTRACT

Approaches presented herein provide for generation of alternate views from disparity data captured for one or more objects in a scene. The generation can be performed using an embedded processor with DMA memory access, or other limited capacity hardware. An intermediate representation can be generated that is a 2D histogram view of the disparity data. This intermediate representation can be transformed, using the embedded processor, to an alternate view image, such as a bird's eye view image. Morphological or similar filtering can be performed on the one or more objects in the intermediate representation using the same size filter, regardless of distance from a camera plane used to capture the disparity data.

### TECHNICAL FIELD

This disclosure relates to the transformation of image data between different views or representations, and in particular in one or more non-limiting embodiments to the generation of an intermediate image representation from a set of disparity data that allows for processing and transformation using limited-capacity resources.

### BACKGROUND

In various computing operations, there is a need to determine the locations of various objects in a scene or geographic region. This can include—for example and without limitation—the analysis of captured image information to support tasks such as navigation, localization, controlled interaction, and collision avoidance for robots and autonomous or semi-autonomous vehicles or machines. Performing operations such as those involving image recognition and computer vision can require significant resource capacity, including the ability to access memory with sufficient capacity to store an entire image. Tasks such as generating a bird's eye view (BEV) representation of a scene from captured disparity data can be difficult, if even possible, to perform using limited capacity resources, such as embedded processors without access to external memory. Further, there are tasks such as morphological filtering and motion analysis that are resource intensive when required to be performed on bird's eye view images where objects at different distances can have different levels of quality or amount of captured information.

### BRIEF DESCRIPTION OF THE DRAWINGS

Various embodiments in accordance with the present disclosure will be described with reference to the drawings, in which:

FIGS. 1A, 1B, 1C, and 1D illustrate image views that can be generated from captured image data, according to at least one embodiment;

FIG. 2A illustrates an intermediate image that can be generated using captured image data, according to at least one embodiment;

FIG. 2B illustrates views of similar objects in both a bird's eye view (BEV) or top-down image and an intermediate histogram image, according to at least one embodiment;

FIG. 3 illustrates corresponding blocks of image data in a disparity image and an intermediate histogram image, according to at least one embodiment;

FIG. 4 illustrates corresponding blocks of image data in an intermediate histogram image and a bird's eye view image, according to at least one embodiment;

FIG. 5 illustrates an example process that can be performed to generate a bird's eye view image from disparity image data using an embedded processor, according to at least one embodiment;

FIG. 6 illustrates an example system including an embedded processor with direct memory access (DMA) functionality, according to at least one embodiment;

FIG. 7A illustrates a comparative view of the amount of detail captured for objects at different distances from a camera, according to at least one embodiment;

FIG. 7B illustrates different size filters needed to process the same amount of detail information for objects at different distances in a bird's eye view image, according to at least one embodiment;

FIG. 8 illustrates a comparison of filter sizes that can be used to process the same amount of detail information for objects at different distances in a bird's eye view image and an intermediate histogram image, according to at least one embodiment;

FIG. 9 illustrates an example process that can be performed using a single filter size for objects at different distances to perform morphological filtering with respect to an intermediate histogram image, according to at least one embodiment;

FIG. 10 illustrates components of a distributed system that can be utilized to generate, process, and provide sensor-based content, according to at least one embodiment;

FIG. 11 illustrates an example computing environment in which one or more devices operate to process data using a SoC, according to at least one embodiment;

FIG. 12 illustrates an example data center system, according to at least one embodiment;

FIG. 13 illustrates a computer system, according to at least one embodiment;

FIG. 14 illustrates a computer system, according to at least one embodiment;

FIG. 15 illustrates at least portions of a graphics processor, according to one or more embodiments;

FIG. 16 illustrates at least portions of a graphics processor, according to one or more embodiments;

FIG. 17A illustrates an example of an autonomous vehicle, according to at least one embodiment;

FIG. 17B illustrates an example of camera locations and fields of view for the autonomous vehicle of FIG. 17A, according to at least one embodiment;

FIG. 17C is a block diagram illustrating an example system architecture for the autonomous vehicle of FIG. 17A, according to at least one embodiment; and

FIG. 17D is a diagram illustrating a system for communication between cloud-based server(s) and the autonomous vehicle of FIG. 17A, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), autonomous vehicles or machines, one or more in-vehicle infotainment systems, one or more emergency vehicle detection systems), piloted and un-piloted robots or robotic platforms, autonomous mobile robots (AMRs), humanoid robots, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, generative AI, cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), vision language models (VLMs), multi-modal language models, etc., systems for performing generative AI operations (e.g., using one or more language models, transformer models, etc.), systems for performing light transport simulation, systems for performing collaborative content creation for 3D assets, systems implemented at least partially using cloud computing resources, and/or other types of systems.

Approaches in accordance with various illustrative embodiments can provide for generation of alternative image view images, such as bird's eye view images, of one or more objects based in part on image data that includes (or can be used to determine) distance information, such as stereo disparity data. In at least one embodiment, such an approach can generate these or other such alternate views in memory-constrained environments and/or for low power operations, for example, such as where there may be no direct access to external memory for an embedded processor equipped with direct memory access (DMA), such as programmable vision accelerator (PVA) from NVIDIA Corporation. Due in part to DMA-related (and other such) limitations, an intermediate representation of a scene can be generated using, for example, stereo disparity data. This intermediate representation can be used to generate a specific view, such as a bird's eye view (BEV) or top-down view of the scene, with each of these operations being DMA-friendly and not requiring access to external memory by the processor; although the DMA can still access the external memory. In at least one embodiment, stereo disparity data can be used to generate an intermediate representation in the form of a (quasi-bird's eye view) 2D histogram, or histogram-type image, that is a function of the camera angle θ and the distance from the camera plane z, represented as H (z, θ). This intermediate representation H (z, θ) can then be transformed into a bird's eye view in cartesian coordinates B (z, x). Such an approach allows for an alternate view image, such as a bird's eye view image, to be generated from stereo disparity data using, for example, an embedded processor with DMA capabilities.

Approaches in accordance with various illustrative embodiments can also provide for processing (e.g., filtering) of data for operations, such as computer vision-related operations. When multiple objects at different distances from a (physical or virtual) camera are represented in an image, those objects would typically be represented by different numbers of pixels and, thus, with different levels of quality. For example, an object that is closer to the camera would typically appear larger in the image and would be represented using a larger number of pixels, while objects (at least of a similar size) that are further from the camera may appear smaller and be represented by a smaller number of pixels, such as even a single pixel. An object far from the camera may thus be represented in the image with very little detail. For alternative image views, such as bird's eye views generated from stereo disparity data, objects at different distances may be treated the same, which provides varying quality results. In other approaches, objects at different distances may be treated differently, which comes with additional complexity and cost due in part to the need to account for the differences in distance. Limitations such as those present due to the use of DMA can prevent such treatment from being performed efficiently, if at all. In at least one embodiment, an intermediate representation can be generated using stereo disparity data. This intermediate representation can then be used to generate an alternate view (e.g., such as a bird's eye view) of a scene, with each of these steps being DMA-friendly (or otherwise able to be run using local memory) and not requiring access to external memory. Such an intermediate representation can take the form of a (quasi-bird's eye view) 2D histogram that is a function of the camera angle H (z, θ). This intermediate representation H(z, θ) can be used to perform various types of processing. Because the intermediate representation is a function of camera angle, nearby objects will appear larger (or are represented using a greater number of pixels) in the intermediate image, and will not lose information when shrunk in the final bird's eye representation. The same filter size can be used for all objects in this intermediate representation, rather than using smaller size filters for objects that are closer to the camera (or larger filters for objects further from the camera) in a bird's eye view, which can avoid any additional complexity to account for distance from the camera. Use of such an intermediate representation also has similar advantages for optical flow-type operations which then also do not need to account for the distance from the camera plane.

Variations of this and other such functionality can be used as well within the scope of the various embodiments as would be apparent to one of ordinary skill in the art in light of the teachings and suggestions contained herein.

There are many computer processes that involve determining the location of objects in a three-dimensional environment. This may include, for example, capturing image and/or sensor data of a physical environment, and generating a digital reconstruction of that environment that can be used for various purposes. This may include, for example, determining how to navigate a robot through a datacenter or performing collision avoidance for an autonomous (or semi-autonomous) vehicle based in part upon the determined location and/or motion of objects in a general proximity in the environment. The data to be analyzed may include stereoscopic data, captured using a pair of matched cameras with a determined spacing, or point cloud data captured using a LiDAR system, among other such options. This data once captured can be used to generate one or more views of at least the portion of the environment represented in the data. In some instances a first type of view might be captured using one or more sensors, but at least a second type of view may need to be generated in order to accurately perform one or more operations. In some instances, data representative of a different view may need to be generated that represents nearby objects in a specific way that is beneficial, or even required, for the intended purpose.

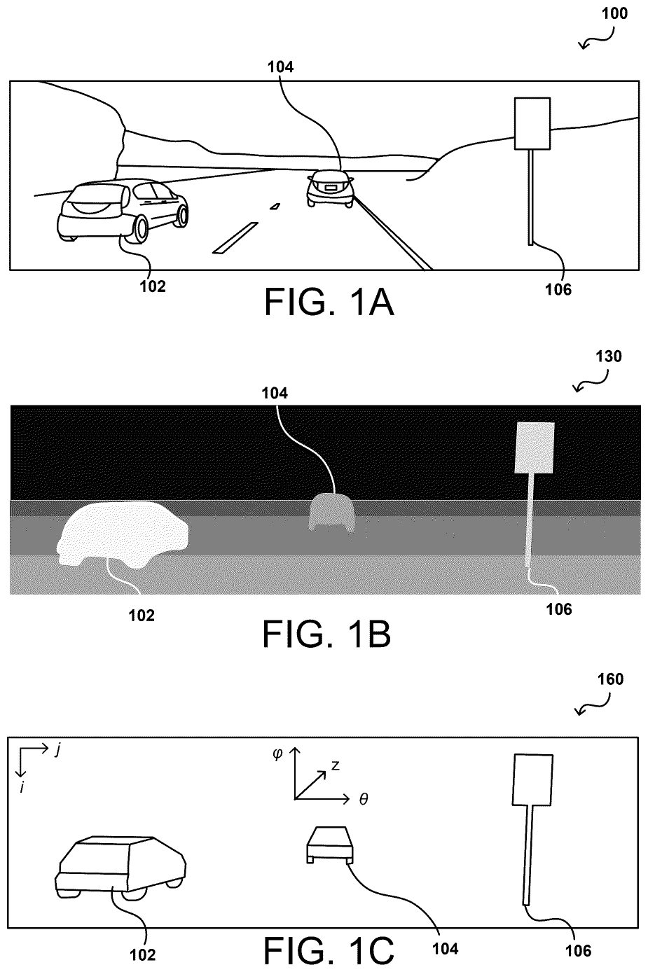

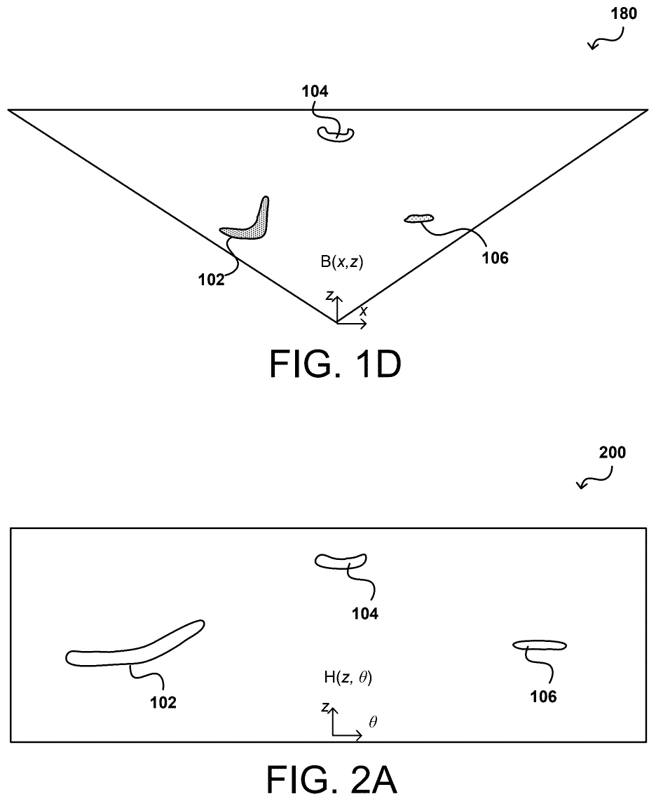

FIG. 1A illustrates an example image 100 that could be captured by a 2D camera on a vehicle, according to at least one embodiment. As mentioned, this may be one of a pair of images captured concurrently by a pair of matched cameras of a stereoscopic imaging system. In this example, the vehicle is traveling along a roadway and the camera is positioned so that the camera view is in front of the vehicle. The camera can then capture image data representative of objects that are at least partially in front of the vehicle and within that camera view. This may include moveable objects, such as pedestrians or other vehicles 102, 104 at least partially in front of the (ego) vehicle, as well as stationary objects such as street signs 106, trees, buildings, sidewalks, and the like. An “ego” vehicle generally refers to a vehicle that has a set of sensors positioned about the vehicle that are able to capture sensor data allowing a control and/or operation system of the vehicle to perceive its surroundings. In at least one embodiment, such a vehicle may have cameras positioned around the vehicle that allow for a full 360 degrees of image data to be captured, such as may be used to generate a 360 top-down or “bird's eye” view of the physical environment surrounding the ego vehicle.

It can be important for tasks such as collision avoidance and route determination to be able to accurately identify the relative locations of various objects in a general proximity of an ego vehicle (or other such controllable system, device, or component), in order to ensure that the vehicle does not improperly collide or interact with any of these objects. As mentioned, a pair of images such as the image 100 illustrated in FIG. 1A can be captured using a pair of matched cameras (e.g., cameras with similar camera and imaging parameters aligned with a common focal length and slight lateral separation) and used to generate a disparity image 130, such as is illustrated in FIG. 1B. Due to the lateral spacing between the pair of matched cameras, each object will appear in slightly different locations in the images captured by those cameras based on a slightly different point of view used for the capture. Objects that are closer to the camera will have a greater difference in apparent location than objects that are further from the camera. By knowing the camera parameters, the distance between locations (or “disparity”) of an object in each of the captured images, often referred to as the “left” image and the “right” image due to lateral separation, the distance to that object from the pair of cameras can be calculated. This can be done for individual pixel locations in the left and right images, and the distance calculated for each such pixel location. This calculated distance to the object represented at each pixel location can then be used to generate a disparity map or disparity image 130, as illustrated in FIG. 1B. In this example disparity image, objects that are closer to the camera will appear brighter, approaching white color values, while objects further from the camera will appear darker. For portions of the image (such as sky) where there are no detectable objects, those portions can be considered to have objects either at infinity or beyond a measurable distance, and may be represented using black color values. As illustrated, it can be determined that one of the vehicles 102 is closer to the camera than another vehicle 104 based on the closer vehicle 102 having a brighter color, representing a shorter distance from the camera. The disparity data for objects in the disparity image will only represent the visible portion of the objects in the image, which in this case includes the back and right side of the vehicle. If complete shape information is needed, then another process can be used that attempts to identify the type of object, then infer additional shape information based on the type of object, such as a specific make, model, and year of vehicle. For tasks such as collision avoidance, however, it may be sufficient to be aware of the portion of the vehicle that is visible and facing an ego vehicle, for example, and thus most likely to be impacted.

In at least one embodiment, the captured image and/or disparity data can be analyzed to attempt to identify specific objects in the data. Identifying objects can involve identifying pixels that, based upon factors such as similarity in location and color, are determined to correspond to a single object, and then potentially identifying the type of object. For example, if the disparity image 130 of FIG. 1B were analyzed using a connected components approach to identify objects within a given distance of the camera, the approach might identify three groups of pixels that likely correspond to specific objects. In some embodiments, specific types of objects such as roadways and sidewalks may be excluded from consideration. The identified objects can then be treated as separate objects, as illustrated in the schematic view image 160 of FIG. 1C. In this example, the two closest vehicles 102, 104 and a road sign are identified as objects that satisfy the current identification criteria. It should be understood that the number of objects recognized in this example is relatively small for purposes of explanation, and that an actual object detection or recognition process may identify many other objects in the disparity image 130 of FIG. 1B. In some embodiments, a connected components-type approach can be used to identify groups of pixels that likely correspond to individual objects, and then an object recognition approach can be used to attempt to identify the type of object, such as to differentiate the vehicles 102, 104 from the street sign 106. Such differentiation can be important for tasks such as object avoidance, as a street sign 106 is fixed in place and will not move over a relevant upcoming period of time, while vehicles may be in motion, or are capable of moving within that upcoming period of time, where that motion should be accounted for in determining appropriate navigation paths or other such options. This example image of FIG. 1C illustrates a schematic view of a typical camera view from a vehicle, where the image has an image coordinate system that starts from an origin in the top left, and expresses pixel coordinates as (i, j), where i corresponds to a vertical axis in the figure and j corresponds to a horizontal axis. The objects represented may be considered to be in camera space, as may correspond to a (φ, θ, z) or similar coordinate system.

For at least some applications, it can be desirable to generate a top-down or bird's eye view (BEV), or calculate such view data, of at least the detected and/or recognized objects in the scene. If using data captured from a single camera (or stereoscopic camera assembly) then the available data will be limited to the objects within the camera view, unless data from multiple cameras is able to be stitched together or otherwise processed to generate a larger view. As an example, FIG. 1D illustrates a bird's eye view image 180 based on the camera image of FIG. 1A. In this bird's eye view image, objects 102, 104, 106 are represented with accurate relative size and location information. As illustrated, since only a portion of each object is visible to the camera, such as one or more sides facing the camera, the representation of each object will include only that portion of each object that is visible to the camera, unless additional processing is performed based to recognize a type of object and then fill in the space for that object. As illustrated, such a bird's eye view image can be in a conventional Cartesian coordinate space, and represented as B(x, y). In such a coordinate system the location of the origin can be important, and will typically correspond to a center point of a lens (or sensor, etc.) of a camera capturing the image data for the scene. The coordinate system for a bird's eye view can be angular with respect to the origin point, such as a coordinate system (φ, θ) representing the pitch and yaw from the origin point.

In conventional approaches, a bird's eye view image 180 can be generated from a disparity image using one or more processors, such as a central processing unit (CPU) or graphics processing unit (GPU). Such a process can also be performed using hardware acceleration (e.g., using a programmable vision accelerator (PVA), a deep learning accelerator (DLA), an optical flow accelerator (OFA), etc.), which can make the generation of the bird's eye view very fast, as may be needed for real time operations such as autonomous or semi-autonomous navigation. In order to perform such processing, however, the processor will need to have access to sufficient memory space, such as external memory, that is able to store all the image data at one time. For high resolution disparity images, this can include more data than is able to fit in limited capacity hardware, such as memory accessible to an embedded processor through DMA or another such mechanism.

In conventional CPU-based systems, a bird's eye view image can also be generated from disparity data without significant concern about data transfers. There may be situations, however, where a processing unit may not have direct access to external memory where the entire set of image data is located. A system used to process captured image and/or sensor data may be limited as to the amount of memory or processing capacity that is available. For example, a system might use an embedded processor equipped with DMA that has no direct access to external memory. Such a device may lack the memory needed to transform a stereo disparity image of a scene into an alternative type of image, such as a bird's eye view of the scene. While such a task may be relatively straightforward on a device with a CPU or GPU, it can be a non-trivial task when needed to be performed on a processing unit, such as an embedded processor, without direct access to the external memory.

In at least one embodiment, a disparity image of a scene can be transformed into an alternate view image, such as a bird's eye view image, using a two-step process. These steps can both be relatively lightweight, such that they both can be able to be run on DMA-based hardware. As an example, data transfers for each of these steps can be performed using a DMA on rectangular regions of input from a disparity image, as well as for data from the intermediate and generated bird's eye view images. It should be understood that there may be additional steps as well, as may be used for pre-processing, post-processing, data conversion, and other such functions, within the scope of at least one embodiment.

In one example, the value of disparity at a given location (i, j) of a disparity image can be represented as D(i, j). The indices i and j are functions of vertical angle φ (representing the pitch) and horizontal angle θ (representing the yaw). In the simplest case of rectified images and with φ and θ measured from the camera axis, while i and j are the usual image coordinates with the origin at top right, as may be given by:

$$i = a φ + b$$

$$j = c θ + d$$

where parameters a, b, c, and d depend at least in part on the intrinsic properties of the camera. The disparity can thus be represented as D(φ, θ) instead of D(i, j). A relationship between the stereo disparity value D and the distance of an object from the camera image plane z can be given by:

$$z = E / D$$

where E is a parameter that depends on camera intrinsics.

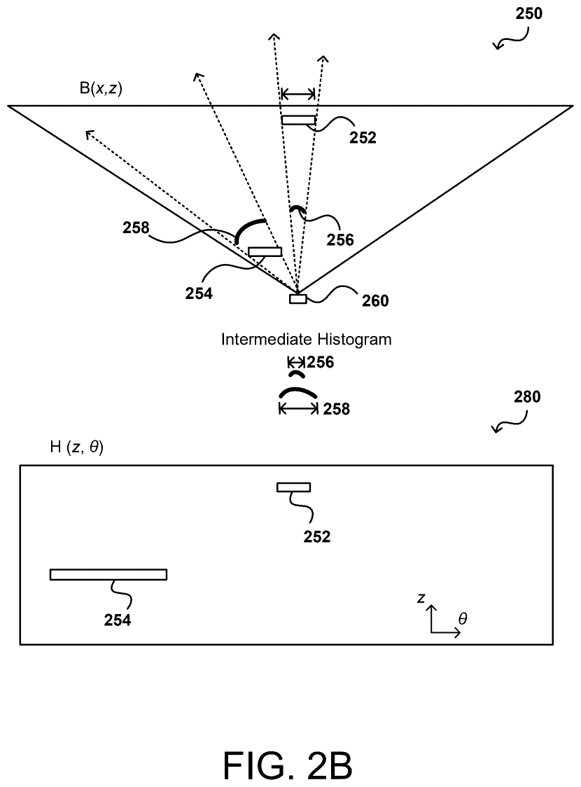

In at least one embodiment, a first step in such a process can be to generate an intermediate image, such as a two-dimensional (2D) histogram or intermediate image 200 as illustrated in FIG. 2A. In this example, the camera is not considered to be at a single point at the bottom center, as in a bird's eye view image, but is effectively across the bottom of the histogram. The histogram values can be represented by H(z, θ), and an element H(z, θ) can be incremented for every pixel D(φ, θ) such that z=E/D, plus or minus the resolution error. Such transformation can create an intermediate image 200 that resembles a top-down view, or bird's eye view image 180, of the scene as represented in the input image. In this intermediate image 200, however, there will likely be at least some inaccuracies in representation of the objects in the scene. These in accuracies are due in part to the fact that objects closer to a (physical or virtual) camera will tend to be represented be spread out, or stretched laterally, as objects closer to the camera will tend to occupy a larger angular spread. FIG. 2B illustrates an example of such a lateral stretch effect based on distance from a camera 260. In the bird's eye view 250 of FIG. 2B, there are two objects 252, 254 illustrated that have the same size and shape. In particular, both objects have the same width in this example. When analyzing in histogram space based on angle, however, the object 254 closer to the camera will occupy a larger angular spread 258 than the angular spread 252 occupied by the object 252 that is further away. In the example illustrated the angular spread 258 for the closer object 254 is two to three times as great as the angular spread 256 for the object 252 that is further from the camera 260. When generating an intermediate histogram image 280 that is a function of angle, as illustrated in FIG. 2B, the height z will not be stretched for the two objects, but the width of the closer object 254 will be stretched in the θ direction by an amount that results in the width of the closer object 254 appearing to be two to three times the width of the object 252 further away from the virtual camera, corresponding to the different in angular range occupied by those objects based on distance even though the objects 252, 254 in actuality have the same width. Referring back to the bird's eye view image 180 of FIG. 1D and the histogram intermediate image 200 of FIG. 2A, this stretching can also impact the appearance of the object, as the stretching of an object 102 also causes it to appear to have a different (e.g., distorted) shape in the intermediate histogram image 200 than in the bird's eye view image 180.

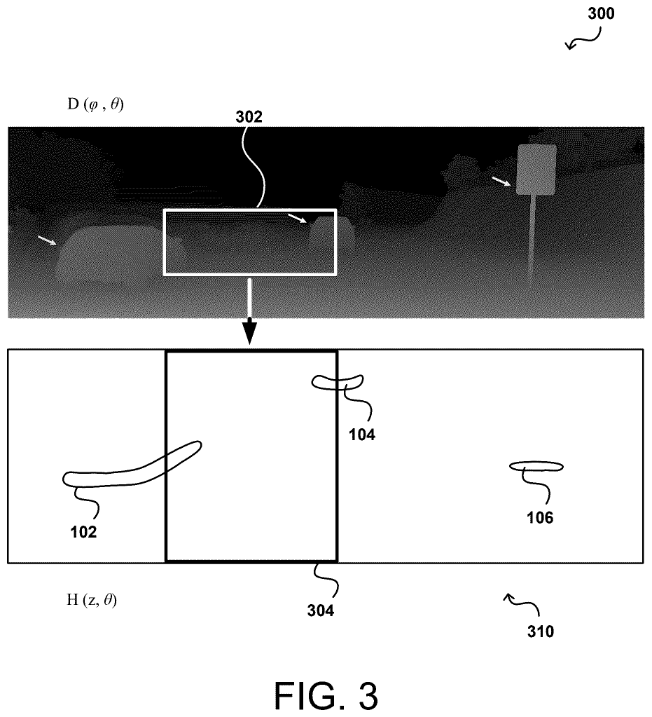

A second step in this example process can be performed to attempt to correct for at least this stretching effect. An example will be used that is illustrated in FIG. 3, where a disparity image 300 is used to generate an intermediate image 310 having the same example objects 102, 104, 106 used as examples previously for simplicity of explanation. An advantage to generating and using an intermediate image 310 in an H(z, θ) coordinate system is that any data in a rectangular region 302 (φ₁:φ₂, θ₁:θ₂) of D(φ, θ) results in increments to H(z, θ) in a rectangular region 304 (0:zₘₐₓ, θ₁:θ₂), which allows for use of DMA. In the disparity image, the pixels within the rectangular regions have values depending on the distance to those objects, which could be anywhere from at the camera lens (for the distance of zero) to effectively infinity or a maximum detectable (or maximum permitted) distance, here set as zₘₐₓ. Accordingly, when that rectangle is transformed into the quasi-bird's eye intermediate image 310, the portion of the corresponding data goes all the way from the camera lens position (represented by the bottom edge of the intermediate image 310) to the maximum distance from the camera (represented by the top edge of the image). It should be understood that there can be other rectangles above and/or below the example rectangular region 302 in the disparity image 300 that also map to the same rectangular region 304 of the intermediate image 310.

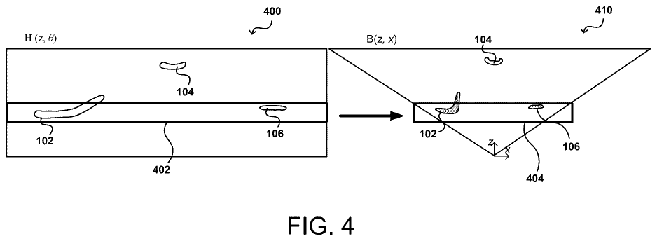

An example process in accordance with at least one embodiment can transform an intermediate image 400 H(z, θ) into a bird's eye view image 410 B(z, x), as illustrated in FIG. 4, and continue the processing on B. An example process can alternatively perform processing on H, generate a list (or set, etc.) of object centroids (or other representative locations) and other statistics in H, and then transform that list into a corresponding list for a bird's eye view image. In either approach, the coordinate transformation can be given by:

$$x = z tan θ$$

Such a task can also be DMA-friendly, for example, as the information from anywhere in row x of intermediate image H(z, θ) influences only row x of the final bird's eye image B(z, x). As illustrated in FIG. 4, a rectangular region 402 of the intermediate histogram image 400 has the same height as the corresponding rectangle 404 for the same portions of represented objects in the bird's eye view image. This is due to the fact that the distances from the camera to the objects are the same in both images, with stretching occurring laterally (or horizontally left-to-right in the figure). The rectangular region 402 in the intermediate image 400 will, however, typically be wider than the corresponding rectangle 404 of the bird's eye view image 410 due to this stretching, where the amount of stretching can be based in part upon the distance from the camera, as objects closer to the camera will be represented in the intermediate image with greater lateral stretching.

Due to the discrete nature of digital images and the contracting effect of multiplication by tan(θ), there be two or more elements of H mapping into the same element of B. In such cases, the values from H may be added, or their maximum value taken, to attempt to resolve this issue. In the case of transformation of lists, that may not be an issue, as long as the approach allows for different objects to occupy the same location in the bird's eye view image. As mentioned, such an approach is advantageous because the steps or tasks can be performed using limited capacity resource, such as embedded processors with DMA.

An advantage to using such a block-based approach is that the image data within a rectangle such as the rectangles 402, 404 illustrated in FIG. 4 is that the rectangles can be selected in size so that the data within a rectangle can be transferred and stored using limited capacity technology, such as DMA. A given rectangular region 402 from an image (such as intermediate image 400) can be selected, the data transferred via DMA and processed by an embedded processor, for example, then stored with respect to the corresponding rectangular region 404 or block in the generated image, such as a bird's eye view image 410. The results can be transferred via DMA to the resulting memory location for that output representation. The sizes of the rectangular regions can be selected based upon various factors, such as the size of the images being processed and the amount of memory transfer available, among other such options. For example, memory may be able to hold around 32 kb of data for input and output, so the rectangle size can have an upper bound selected so the amount of data within that region falls within an available portion of the 32 kb, taking into account factors such as the resolutions of the images. The number of rectangular regions used can then be calculated based on the total amount of data and the amount of data that can be contained in the various rectangular regions. In at least one embodiment the rectangular regions may all be of the same size, although in other embodiments the size or shape of the rectangular regions may vary if there is a performance advantage, as long as the size and shape remains within the allowable parameters. In at least one embodiment, an intermediate image can be processed using 10 rectangular regions horizontally and 10 rectangular regions vertically, for a total of 100 rectangular regions or tiles. The blocks of data can be processed as tiles of an image, where each pixel falls within a given tile, and the tiles can be processed separately without impact on the quality of the resulting output. Processing such as sharpening or low-pass filtering can be performed on individual tiles, due in part to the very local nature of this type of processing. Benefits of the rectangular correspondences between an intermediate image and a bird's eye view image, in particular as to where the data can go and how the data relates between the two images, allows for implementation of a relatively complicated transformation from a camera view image to a bird's eye view image using limited capacity hardware, such as an embedded processor with DMA, or another dedicated processing unit or core with limited memory and/or transfer capability.

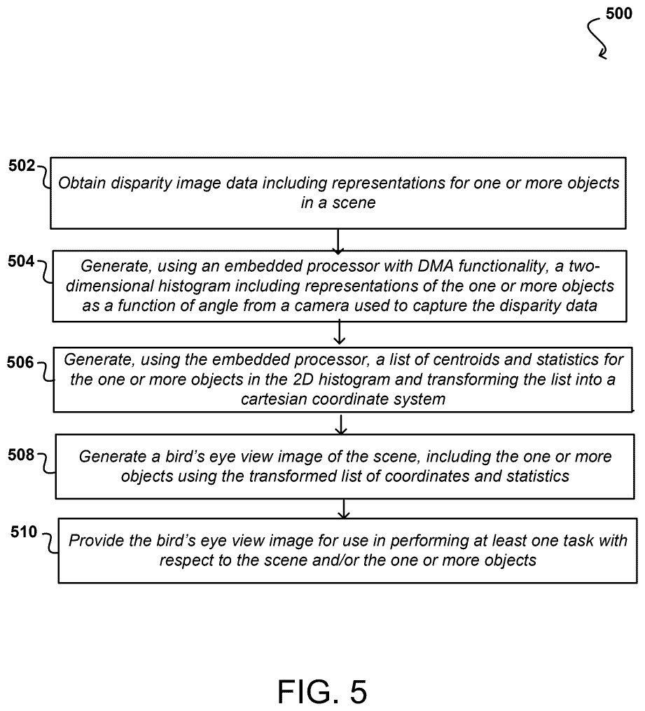

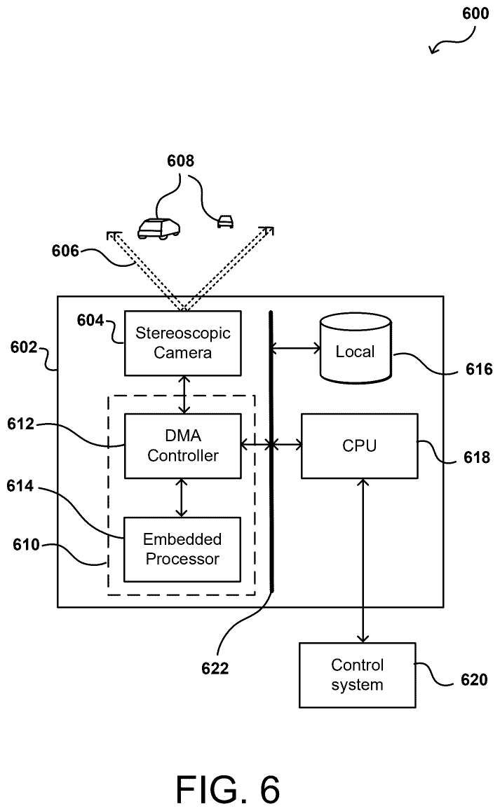

FIG. 5 illustrates an example computing process 500 that can be performed to generate an alternate view image, such as a bird's eye view image, from a camera view image, according to at least one embodiment. It should be understood that for these and other processes presented herein there may be additional, fewer, or alternative steps performed in similar or alternative orders, or at least partially in parallel, within the scope of the various embodiments unless otherwise specifically stated. Further, although this example will be discussed with respect to a camera view image and a bird's eye view image, there may be other types of image transformation performed using such a process within the scope of various embodiments. Such a computing process may be performed using any combination of hardware, firmware, and/or software. For instance, various functions may be carried out using one or more processors executing instructions stored in one or more memories. Such a process may also be embodied as computer-usable instructions stored on computer storage media. This process may be provided by a standalone application, a service or hosted service (standalone or in combination with another hosted service), as a microservice via an application programming interface (API) or a plug-in to another product, to name a few. In addition, this process is described, by way of example, with respect to the system of FIG. 6. However, such a process may additionally or alternatively be executed by any one system, or any combination of systems, including, but not limited to, those described herein.

In this example computing process 500, disparity image data is obtained 502 that includes representations for one or more objects in a scene. This may include, for example, receiving disparity image data from a stereoscopic camera assembly (or imaging device) positioned so that the one or more objects fall within a view of the camera assembly. There may be other and/or additional types of data captured using one or more sensors as well, where the additional type(s) of data may provide visual, shape, motion, or other such data with respect to the objects, where the data can have specific values or values relative to those of the camera assembly or vehicle/system to which the camera assembly is attached. In this example, the hardware allocated to process the disparity image data can include limited capacity hardware, such as may include an embedded processor with DMA functionality. This embedded processor can be used to generate 504 a two-dimensional histogram including representations of the one or more objects as a function of angle from the camera assembly that was used to capture the disparity data. This histogram, or intermediate image, can be a function of distance and angle from the camera assembly, and can function as a quasi-bird's eye view image. The embedded processor can also be used to generate 506 a list of centroids and statistics (or other such location indicators and/or metrics) for the one or more objects in the 2D histogram, and can transform the values in this list to be represented in a cartesian coordinate system. A bird's eye view image of the scene can be generated 508 that includes top-view representations of the one or more objects as transformed using the list of coordinates and statistics. The transferring and analysis of image data can occur using blocks, tiles, or rectangular regions of pixels from the intermediate image, which allows for transfer, processing, and storage by the embedded processor without access at any given time to all the image data as may be stored in an external memory. The bird's eye view image can then be provided 510 for use in performing at least one tack with respect to the scene and/or the one or more objects. This may include, for example, determining a navigation path or interaction sequence with respect to the object(s) in the scene, or nearby environment. In other embodiments, the data may be stored for subsequent use and analysis, or provided for use in performing other types of tasks.

FIG. 6 illustrates an example system 600 in which an embedded processor 614 can be used to perform tasks such as image transformation, in accordance with at least one embodiment. In this example, a computer system 602 includes (or at least communicates with) a stereoscopic camera 604 that is able to capture stereoscopic image data of one or more objects 608 within a field of view 606 (or at least overlapping field of view) of the stereoscopic camera assembly. As mentioned, various other types of sensors or devices can be used to capture information about the objects as well within the scope of the various embodiments. In this example, the captured image data can be stored to a local memory 616, external memory, or other such location. The local memory may be connected to a central processing unit (CPU) 618 or other such processor (e.g., a GPU or DPU), such as by a system bus 622, that allows the CPU to process the image data that is all accessible from the local storage 616. In this example, however, the computing system 602 may include, or at least work with, an image processing module 610. The image processing module may include an embedded processor 614 that may not have access to the local storage 616 (that is external to the image processing module), and may only be able to access portions of the image data via a DMA controller 612 or other such data transfer mechanism. As discussed herein, blocks of image data can be transferred via DMA to be processed by the embedded processor 614. For image transformation, an intermediate image can be generated by the embedded processor 614 receiving blocks of the stereoscopic image data (or disparity image data) from the stereoscopic camera 604. The embedded processor can then transform the intermediate image into an alternate view image, such as a bird's eye view image, using a block-based approach that processes portions of the image data separately. Tasks such as connected components analysis and centroid calculation used for the transformation can be performed using the embedded processor. The bird's eye view image can then be provided, directly or via the CPU 618 or system bus 622, to a control system 620 or other such destination or recipient, to be used for one or more tasks such as autonomous navigation, collision avoidance, or object interaction, among other such options. In this example, the image processing module 610 may be a system on chip (SoC), which may be used by, or may include, at least some of the camera circuitry. The embedded processor 614 can be used as a co-processor, or offload processor, for the CPU 618 or other such processor, such as a digital signal processor (DSP). Using DMA in systems including DSPs can allow for tight control over data movement while also avoiding significant caching of data, management of memory address space, and other such tasks.

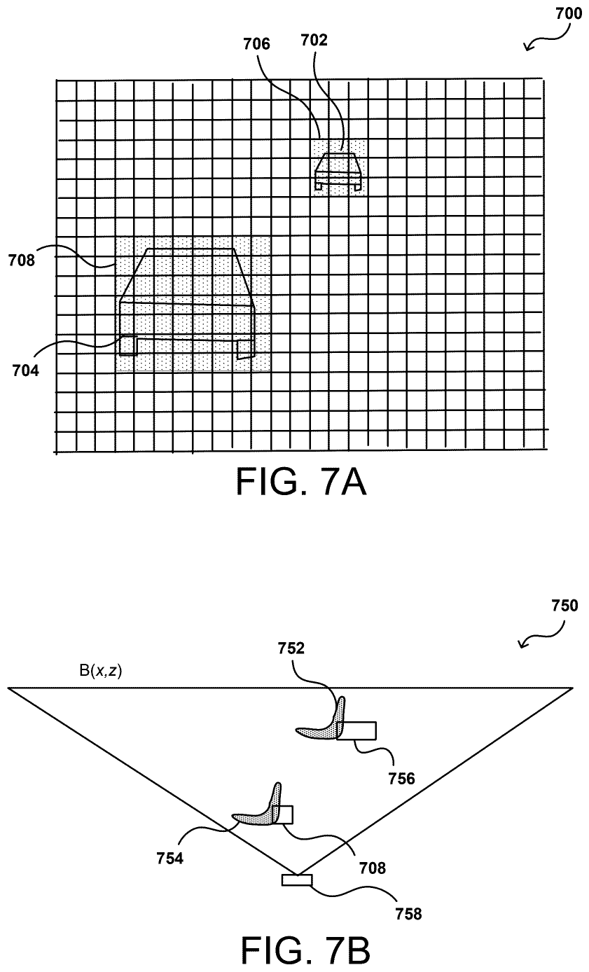

As discussed above, one of the challenges in computer vision and image understanding is the fact that objects represented at a greater distance from a (physical or virtual) camera will necessarily appear smaller in images captured or generated using that camera. Consider the captured camera view image 700 of FIG. 7A, as may represent one image of a pair of stereoscopic images. In this image, there are two objects 702, 704 that are of approximately the same size. As illustrated, the object 702 further from a virtual camera appears smaller, and is represented by a relatively small number (e.g., 9) or array of pixels 706. The object 704 closer to the camera has a larger representation in the image, here represented by a greater number (e.g., 56) of pixels. The smaller number of pixels associated with objects further from the camera can result in lower quality representations of those images, including less information about the shape, appearance, and other properties of these distant objects, with respect to objects that are closer to the camera. Such effect can be observed in particular when the scene from a camera view is transformed and processed in the bird's eye view, such as the image 750 of FIG. 7B, particularly when considering an occupancy grid or occupancy map. In this example, there are two objects 752, 754 of similar size but at different distances from the position of the camera 758. These objects at different distances could be processed using the same analysis functions, but such an approach may be suboptimal due in part to the varying amount of information content for these objects. An alternative approach would be to use different analysis functions for objects at different distances, but such an approach adds additional complexity and cost due to the need to determine and account for different distances, including processing the objects differently based on their respective distances from the camera. As mentioned previously, it can be desired to perform processing of such images on limited capacity hardware in certain situations, and such additional processing and complexity may prove problematic for that hardware, at least while meeting various performance criteria.

Approaches discussed previously herein allow for a two-step transformation of disparity images to alternate view images, such as bird's eye view images, of a scene that can be implemented using one or more limited capacity resources, such as an embedded processor with DMA functionality. Such an approach can generate an intermediate representation H(z, θ) of the bird's eye view, which intrinsically has a greater number of occupancy cells covering objects closer to the camera due in part to the lateral stretching effect discussed previously. This is in contrast to a generated bird's eye view image 750, as illustrated in FIG. 7B. In this example image, the objects are illustrated to be of the same size. The amount of information available for each will be limited, however, such as is illustrated in FIG. 7A due in part to the different number of pixels based on distance from the camera. In a bird's eye view which will be isometric, an object occupies the same number of grid cells regardless of its position or distance from the camera. In the example of FIG. 7A, however, the object 704 closer to the camera has around six times more information available due to the greater number of pixels that were present in the captured representation of those objects. In the bird's eye view of FIG. 7B, to make the objects appear the same size means either stretching the pixels for the object 752 further from the camera, or compressing the pixels for the object 754 closer to the camera. Pixels from the disparity view are accumulated into the bird's eye view and various types of image processing can be performed to connect these pixels into a single object of the appropriate size.

In such a bird's eye image 750, use of filters of the same size will result in different amounts of information being processed for different objects at different distances, which can impact quality as discussed previously. As mentioned, one way to make sure that similar amounts of information are used for each filter (or algorithm, etc.) is to use different size filters for objects at different distances. One approach would be to attempt to use filters that result in the same number of pixels or data from the captured image being captured by each filter. As illustrated, this may result in a filter 756 of a first size for the object at a greater distance from the camera 758. This filter may capture about 9 pixels worth of information for this distance object (as may include some pixels in a region of the object but not corresponding to the object). If a similar filter is to be used for the closer object 754 that is to capture about 9 pixels worth of information for the closer object 754, that filter would need to be smaller in size. Different sized filters would need to be used in such an approach for each different distance, or at least over ranges of distance as may be based in part on a resolution of the original captured image data. As mentioned, this need to determine and use multiple filter sizes (or differ algorithms, etc.) can result in additional processing and memory requirements which may be difficult to satisfy using, for example, limited capacity hardware.

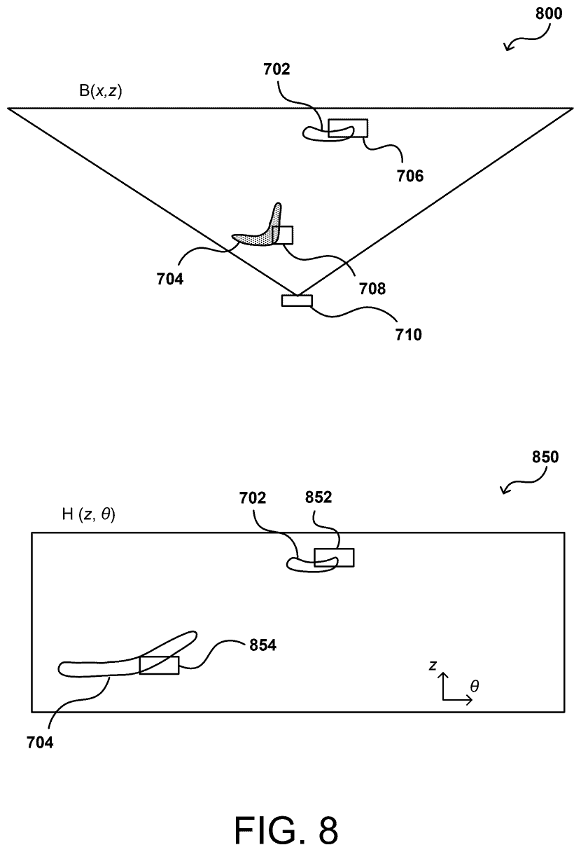

In order to avoid the use of different filter sizes or algorithms for objects at different distances from a camera, approaches in accordance with various embodiments can use an intermediate representation image, such as those discussed previously herein, which allow for use of the same size filters for various objects independent of their distance from the camera. As discussed, such an intermediate image does not suffer the problem of different numbers of occupancy cells covering objects closer to the camera. In such an intermediate representation of the occupancy grid, nearby objects will appear larger due to the lateral stretching effect with respect to objects further from the camera. The amount of stretching is inversely proportional to the distance from the camera (although in other embodiments there could be compression that is directly proportional to distance instead). Because the amount of stretching is inversely proportional to distance, the same size filter can be used for all objects in an intermediate image regardless of distance from the camera. For example, in the intermediate image 850 of FIG. 8, there are two filters 852, 854 illustrated for use with respective objects 702, 704. Due in part to the stretching of the closer object 704 in the intermediate image 850, each filter 852, 854 will process a region that corresponds to approximately the same number of pixels of the original captured image. Such an approach can also help prevent loss of information for objects closer to the camera that might otherwise occur if those objects are shrunk or compressed in the final occupancy grid.

In at least one embodiment, using a single filter of a determined size on all objects in an intermediate image is equivalent to using smaller filter sizes (or finer filters) used on objects closer to the camera, and/or using larger filter sizes being on more distant objects in the final occupancy grid. Use of a single size filter can also be accomplished without any additional complexity to account for the distance from the camera. Further advantages can be obtained when using an optical flow map to estimate the motion of objects. When calculated by averaging the optical flow over the object in the camera view, this motion can be directly used in (z, θ) space, without the need to take the distance from the camera plane (z) into account. Processing of the occupancy grid information can thus be performed in such a (z, θ) space representation of the occupancy grid, and not in the occupancy grid domain itself.

In one example of a type of analysis that may be performed using such filters or algorithms, the pixel data is to be analyzed to attempt to identify objects in the image, and determine which pixels correspond to specific objects. While such a process may be relatively straightforward for a human viewing the image, making such determinations in software can be relatively complicated and/or time and resource intensive. As an example, an input image may need to be analyzed using a connected components algorithm (or similar approach) to connect related pixels as associated with a single object. Individual pixels can then be labeled or otherwise indicated as being associated with specific objects. Using filters that are unnecessarily large can make it difficult to distinguish between nearby objects, and may end up having those objects improperly identified as a larger single object. Similarly, using filters that are too small may end up in an object getting improperly identified as two or more smaller objects.

In order to provide for accurate pixel groupings, some amount of additional pre-processing may also need to be performed, as may include dilation and/or erosion operations to attempt to denoise the data (as input image data in various systems may include an unacceptable amount of noise in many instances) by, in part, changing the size of shape of one or more objects in an image. Erosion typically involves removing pixels from boundaries of objects in order to shrink the overall size of the object representations in the image data and eliminate edge pixels whose value may be significantly impacted by regions not associated with the object (e.g., background objects). Dilation can be used to add pixels proximate boundaries of objects to expand the size of the object representations, which can also help to join broken or separated portions of an object in an image, which can be helpful for performing connected components and other types of analysis. Erosion can be used to remove noise but results in smaller object representations, so dilation can be used to recover the lost object area.

Pixels may go through some amount of morphological filtering before being processed using a connected components (or similar) approach. Image data for objects that appear smaller in an image due to distance from the camera will tend to be noisier than image data for closer objects, as there are fewer pixels representing the appearance (and other such properties) of the further objects, which can result in a lack of fine detail as well as inaccuracies in pixel values due to the need to attempt to select a pixel value for a given location based in part upon potentially many different colors around that location, where the final pixel value for that location in the image may be very different from the actual color at that location. In such a situation, it may be preferable to use a larger filter on the noisier objects. Using a larger filter on closer and less noisy images may result in loss of accurate or quality image data captured for these larger and less noisy object representations.

As mentioned, it can be beneficial to perform such morphological (and other types of) filtering using an intermediate representation image, as a single size and type of filter can be used for all regions of the image, regardless of the distance of a respective object from the camera. Using the same size filter at each location also allows for use of simpler algorithms and reduced processing and data transfer. FIG. 8 again illustrates a bird's eye view 800 of a pair of objects in a scene, where filters of a different size would need to be used to process the same amount of actual captured image (or other such) data. By comparison, an intermediate image 850 for the same set of objects will have objects closer to the camera stretched by an amount that is inversely proportional to distance from the camera, such that filters of the same size can be used for each region and will contain information for the same number of pixels in the original captured image data. When comparing the portions of each object represented by filters in the bird's eye view 800 versus the intermediate image, it can be seen that essentially the same portion of an object is represented in the filter for each, such as a very similar portion of the closer object 704 being represented in the smaller filter 708 in the bird's eye view 800 and the same size filter 854 of the intermediate representation 850. In this way, the same amount of pixel data is being processed for each filter, without the need for different filters for objects at different distances from the camera. Similar advantages can be obtained when performing motion analysis or estimation. The size and type of filter can vary for different use cases, and in some instances different filters can be used to determine preferred visual quality, which can be subjective and may vary for different use cases or intended purposes. For example, in navigation use cases it may be more important to get the shape correct than have the objects appear as accurate as possible, while in presentation-based use cases it may be more important to have high quality for certain visual aspects while a precise shape or location of a given object may not be critical.

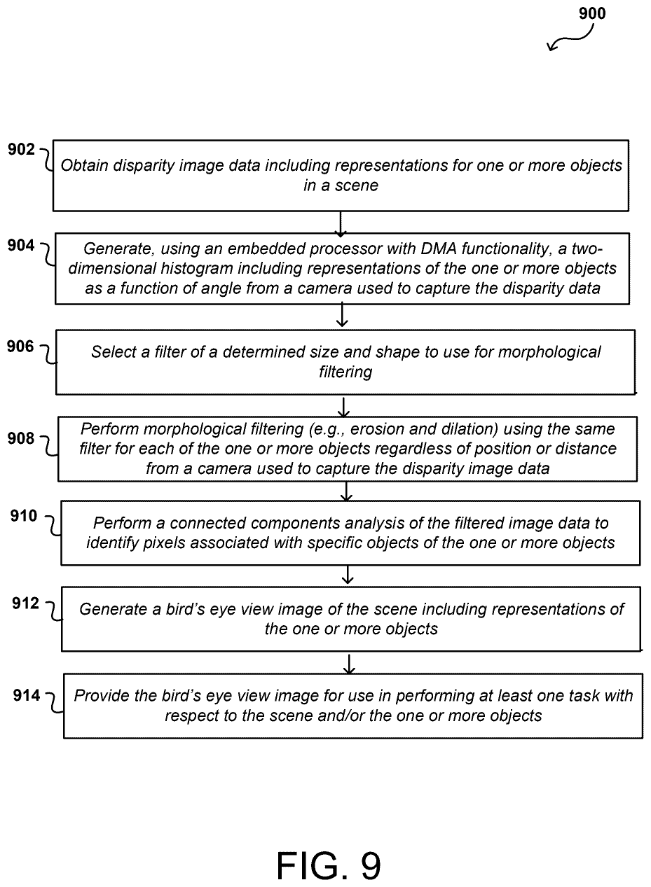

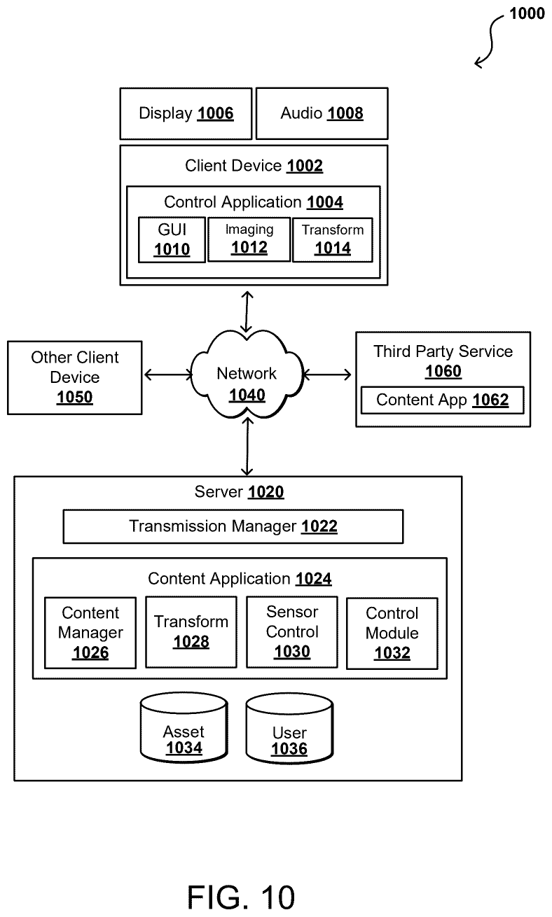

FIG. 9 illustrates an example computing process 900 that can be performed to perform consistent and efficient filtering during image transformation, according to at least one embodiment. In this example, disparity image data is obtained 902 that includes representations of one or more images in a scene, such as is discussed with respect to the example process of FIG. 5. In this example, the hardware allocated to process the disparity image data can include limited capacity hardware, such as may include an embedded processor with DMA functionality. This embedded processor can be used to generate 904 a two-dimensional histogram including representations of the one or more objects as a function of angle from the camera assembly that was used to capture the disparity data. This histogram, or intermediate image, can be a function of distance and angle from the camera assembly, and can function as a quasi-bird's eye view image. In this example, morphological filtering is to be performed to attempt to reduce noise and otherwise improve the quality of the image data to be transformed. A filter of a determined size and shape can be selected 906 that is to be used for the morphological filtering and/or other such processing, or pre-processing. Morphological filtering can then be performed 908 using the same determined filter size and shape for all locations in the input image, including each of the one or more objects regardless of the position or distance of those objects from the camera having captured the disparity image data. The filtering can include, for example, erosion to remove noise and dilation to attempt to recover any data that was lost during erosion. In this example, a connected components analysis of the filtered image data can be performed 910 to identify pixels that are associated with individual or specific objects of the one or more objects. Such an approach effectively identifies which pixels in the image data are (at least mostly) associated with each object. Such an approach can be beneficial when performing an image transformation that is based on aspects such as a list of object centroids, where it can be important to determine an accurate size and shape of the objects to make accurate centroid determinations. An alternate view image, such as a bird's eye view image, can be generated 912 for the scene that includes top-down representations of the one or more objects, based on a transformation from the two-dimensional histogram. The bird's eye view image can then be provided 914 for use in performing at least one tack with respect to the scene and/or the one or more objects. This may include, for example, determining a navigation path or interaction sequence with respect to the object(s) in the scene, or nearby environment. In other embodiments, the data may be stored for subsequent use and analysis, or provided for use in performing other types of tasks.

Aspects of various approaches presented herein can be lightweight enough to execute in various locations, such as on a device such as a client device that include a personal computer or gaming console, in real time. Such processing can be performed on, or for, content that is generated on, or received by, that client device or received from an external source, such as streaming data or other content received over at least one network from a cloud server 1020 or third party service 1060, among other such options, as illustrated in FIG. 10. In some instances, at least a portion of the processing, generation, compositing, and/or determination of this content may be performed by one of these other devices, systems, or entities, then provided to the client device (or another such recipient) for presentation or another such use.

As an example, FIG. 10 illustrates an example network configuration 1000 that can be used to provide, generate, modify, encode, process, and/or transmit data, requests, or other such content. In at least one embodiment, a client device 1002 can generate or receive data for a session using components of a content application 1004 on client device 1002 and data stored locally on that client device. In at least one embodiment, a content application 1024 executing on a server 1020 (e.g., a cloud server or edge server) may initiate a session associated with at least one client device 1002, as may utilize a session manager and user data stored in a user database 1036, and can cause content such as one or more images or image data to be captured or obtained, such as from an asset repository 1034, as determined by a content manager 1026. A content manager 1026 may work with one or more transformation modules 1028 to transform between image views, such as from a disparity image to a bird's eye view image. A content application 1026 can also work with a sensor control module 1030 that can cause the capture and/or pre-processing of sensor data, as well as a control module 1032 that may perform various operations based on the sensor data as transformed using the transformation module 1028. Transformed image data can also be provided for processing or presentation via the client device 1002. In this example, the content application 1024 can receive disparity data captured by the client device 1002 and can return an alternate view image transformed by the transformation module 1028. In at least one embodiment, the content application 1024 can work with one or more encoders, transcoders, and/or compressors that can perform tasks such as encoding, decoding, compression, and/or decompression of an instance of content, such as image data before or after transformation, where different compressions or encodings may be beneficial for different operations, such as for storage versus processing. At least a portion of the generated, captured, transformed, and/or compressed content may be transmitted to the client device 1002 using an appropriate transmission manager 1022 to send by download, streaming, or another such transmission channel. An encoder may be used to encode and/or compress at least some of this data before transmitting to the client device 1002. In at least one embodiment, the client device 1002 receiving such content can provide this content to a corresponding content application 1004, which may also or alternatively include a graphical user interface 1010, imaging control module 1012 and a transformation module 1014. for use in providing, synthesizing, rendering, compositing, modifying, transforming, or using image- or sensor-based content for presentation (or other purposes) on or by the client device 1002. A decoder may also be used to decode data received over the network(s) 1040 for presentation via client device 1002, such as image or video content through a display 1006 and audio, such as sounds and music, through at least one audio playback device 1008, such as speakers or headphones. In at least one embodiment, at least some of this content may already be stored on, rendered on, or accessible to client device 1002 such that transmission over network 1040 is not required for at least that portion of content, such as where that content may have been previously downloaded or stored locally on a hard drive or optical disk. In at least one embodiment, a transmission mechanism such as data streaming can be used to transfer this content from server 1020, or user database 1036, to client device 1002. In at least one embodiment, at least a portion of this content can be obtained, enhanced, and/or streamed from another source, such as a third party service 1060 or other client device 1050, that may also include a content application 1062 for generating, enhancing, or providing content. In at least one embodiment, portions of this functionality can be performed using multiple computing devices, or multiple processors within one or more computing devices, such as may include a combination of CPUs and GPUs.

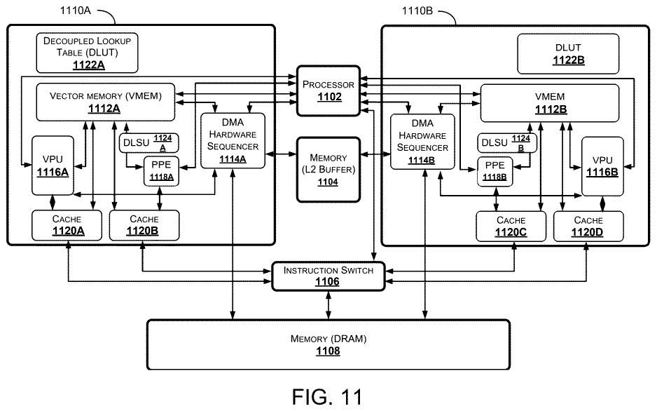

FIG. 11 illustrates components of an example system or operating environment in which image transformation can be performed according to at least one embodiment. Such an environment 1100 can include processor 1102, memory 1104, instruction switch 1106, memory 1108 (sometimes referred to as dynamic random access memory or DRAM), and functional blocks 1110a, 1110b (referred to individually as functional block 1110 and collectively as functional blocks 1110 unless otherwise specified). In some embodiments, the processor 1102, memory 1104, instruction switch 1106, memory 1108, and functional blocks 1110 can interconnect (e.g., establish a connection to communicate and/or the like) via wired and/or wireless connections. In some embodiments, the components of the environment 1100 can be included in a system on a chip (SoC). For example, the components of the environment 1100 can be included in one or more SoCs that form integrated circuits by combining some or all of the component of the environment 1100.

The processor 1102 can include one or more processors such as one or more central processing units (CPUs), graphical processing units (GPUs), microprocessors, microcontrollers, and/or the like. The processor 1102 can interconnect with an instruction cache (not explicitly shown) that stores instructions for the processor 1102 to execute. In some embodiments, the processor 1102 can be configured to output data associated with configuration and/or control of one or more of the devices of FIG. 11. For example, the processor 1102 can be configured to output data associated with configuration of a direct memory access (DMA) hardware sequencer 1114a and/or DMA hardware sequencer 1114b to control DMA transfers to and/or from vector memory (VMEM) 1112a and/or VMEM 1112b of functional block 1110a and functional block 1110b, respectively.

The memory 1104 (sometimes referred to as an L2 buffer or L2 cache) can include a storage device that is interconnected with the DMA hardware sequencer 1114a and/or the DMA hardware sequencer 1114b of the functional blocks 1110. In some embodiments, the memory 1104 can be configured to receive and store data from the DMA hardware sequencer 1114a and/or the DMA hardware sequencer 1114b of the functional blocks 1110 as described herein. In some embodiments, the memory 1104 can have one or more (e.g., 2) banks that enable simultaneous read or write requests. For example, the memory 1104 can have a first bank that is associated with the DMA hardware sequencer 1114a and a second bank that is associated with the DMA hardware sequencer 1114b.

The instruction switch 1106 can include one or more processors that are configured to scan the memory 1108, receive data from the memory 1108, cause data stored in the memory 1108 and/or in local memory to the instruction switch 1106 to be loaded into the VMEM 1112, and/or the like. For example, the instruction switch 1106 can be coupled to the memory 1108 and/or include internal memory that has stored thereon instructions involved in operating one or more of the devices of the corresponding functional blocks 1110. In an example, the instruction switch 1106 can be configured to obtain and provide data associated with instructions to perform one or more DMA transfers as described herein. In another example, the instruction switch 1106 can be configured to obtain and provide data associated with instructions to perform one or more operations specific to one or more devices of the functional blocks 1110. In an illustrative example, the instruction switch 1106 can be configured to obtain and provide data associated with instructions to perform one or more filtering operations and the instruction switch 1106 can transmit the data to caches 1120 of corresponding functional blocks 1110. In this illustrative example, the corresponding caches 1120 can be configured to transmit (e.g., load) the data associated with the instructions into the VPU 1116 or PPE 1118 to cause the respective device to perform the one or more filtering operations.

The memory 1108 can include a storage device that is interconnected with the DMA hardware sequencer 1114a and/or the DMA hardware sequencer 1114b of the functional blocks 1110. In some embodiments, the memory 1108 can receive and store sensor data generated by one or more sensors of a robot. For example, during operation of the robot, the memory 1108 can be configured to receive data based at least in part on a direct interconnection with the one or more sensors or an indirect interconnection with the one or more sensors (e.g., via communication through a CAN bus and/or the like). In these examples, the sensor data can include image data associated with one or more images generated by one or more cameras, LiDAR data associated with one or more LiDAR data associated with one or more point clouds generated by one or more LiDAR sensors, radar data associated with one or more radar images generated by one or more radar sensors, and/or the like. In some embodiments, the memory 1108 can be configured to provide (e.g., transmit) the sensor data stored therein to one or more components of the functional blocks 1110. For example, during processing of the one or more images generated by the one or more cameras of the robot, the DMA hardware sequencer 1114a and/or DMA hardware sequencer 1114b can obtain the image data from the memory 1108 and cause the image data to be stored in the VMEM 1112a and/or VMEM 1112b, respectively. In some embodiments, the memory 1108 can receive and store data from the DMA hardware sequencer 1114a and/or the DMA hardware sequencer 1114b of the functional blocks 1110. For example, the DMA hardware sequencer 1114a and/or DMA hardware sequencer 1114b can provide image data that was updated based at least in part on the processing of the image data to the memory 1108 and the memory 1108 can store the image data that was updated in the memory 1108.

Functional blocks 1110 can include VMEMs 1112a, 1112b, DMA hardware sequencers 1114a, 1114b, vector processing units (VPUs) 1116a, 1116b, pixel processing engines (PPE) 1118a, 1118b, caches 1120a, 1120b, 1120c, 1120d, and decoupled lookup tables (DLUTs) 1122a, 1122b. For purposes of clarity, each will be referred to individually as VMEM 1112, DMA hardware sequencer 1114, VPU 1116, PPE 1118, cache 1120, and DLUT 1122, and collectively as VMEMs 1112, DMA hardware sequencers 1114, VPUs 1116, PPEs 1118, caches 1120, and DLUTs 1122 unless otherwise specified. While certain interconnections are illustrated, it will be understood that the connections illustrated are for simplicity and that one or more of the devices of the functional blocks 1110 can interconnect with one or more other devices of the functional blocks 1110 unless expressly stated otherwise.

The VMEMs 1112 can include a storage device that is interconnected with the processor 1102 and the respective DMA hardware sequencers 1114, VPUs 1116, PPEs 1118, and caches 1120 of the functional blocks 1110. In some embodiments, the VMEMs 1112 can receive and store the sensor data obtained from the memory 1108. For example, the VMEMs 1112 can receive and store the sensor data obtained from the memory 1108 by the DMA hardware sequencers 1114. Additionally, or alternatively, VMEMs 1112 can receive and store the sensor data obtained from the memory 1108 via the instruction switch 1106. In some embodiments, the VMEMs 1112 can interconnect with the PPEs 1118 via decoupled load/store units (DLSUs) 1124. As described herein, the DLSUs 1124 can be configured to buffer data communicated between the VMEMs 1112 and the PPEs 1118 to reduce latencies associated with communication between the VMEMs 1112 and the PPEs 1118.

The DMA hardware sequencers 1114 can include one or more processors that control the execution of one or more instructions. For example, the DMA hardware sequencers 1114 can receive instructions from the processor 1102, the respective VPUs 1116 or PPEs 1118, and/or a storage device (e.g., a device associated with the DMA hardware sequencers 1114 such as internal or external memory, not explicitly shown) and the DMA hardware sequencers 1114 can coordinate with the respective VPUs 1116 and/or the PPEs 1118 to perform one or more operations during execution of the instructions. In one illustrative example, the DMA hardware sequencers 1114 can receive instructions that cause the DMA hardware sequencers 1114 to obtain data (e.g., sensor data and/or the like) from the memory 1108 and store the data in the respective VMEMs 1112. In some embodiments, the DMA hardware sequencers 1114 can perform one or more operations based at least in part on the data obtained from the memory 1108. For example, the DMA hardware sequencers 1114 can pad frames (e.g., image frames), manipulate addresses, manage overlapping data, manage different traversal orders, account for different frame sizes, and/or the like. In some embodiments, the DMA hardware sequencers 1114 can receive signals (e.g., from the VPUs 1116 or PPEs 1118) indicating that one or more operations were performed on the data stored in the VMEMs 1112, update one or more descriptors based at least in part on the updates to the data, and again perform operations on the data.

The VPUs 1116 can include one or more processors that execute one or more instructions. For example, the VPUs 1116 can receive instructions from the processor 1102 and the respective VPUs 1116 can coordinate with the DMA hardware sequencers 1114 and/or PPEs 1118 to perform the one or more operations during execution of the instructions. In one illustrative example, the VPUs 1116 can receive instructions from the processor 1102 that cause the VPUs 1116 to trigger respective DMA hardware sequencers 1114 to obtain sensor data from the memory 1108 and store the sensor data in the respective VMEMs 1112. In examples, the VPUs 1116 can process the data stored in the respective VMEMs 1112 and write data back to the VMEMs 1112. In these examples, the data written by the VPUs 1116 into respective VMEMs 1112 can include updated sensor data and/or data generated based at least in part on analysis performed by the VPUs 1116 on the sensor data, including object or feature locations within a frame, a classification indicating a type of an object or agent, and/or the like. In some embodiments, the VPUs 1116 can provide (e.g., send, transmit, transfer, etc.) a signal to the respective DMA hardware sequencers 1114 to cause the DMA hardware sequencers 1114 to update one or more descriptors (described herein). For example, the VPUs 1116 can send a signal to the respective DMA hardware sequencers 1114 to cause the DMA hardware sequencers 1114 to update one or more descriptors based at least in part on the data written by the VPUs 1116 to the respective VMEMs 1112.

The PPEs 1118 can include one or more processors that execute one or more instructions. For example, the PPEs 1118 can receive instructions from the processor 1102 and the respective PPEs 1118 can coordinate with the DMA hardware sequencers 1114 and/or VPUs 1116 to perform the one or more operations during execution of the instructions. In one illustrative example, the PPEs 1118 can receive instructions from the processor 1102 that cause the PPEs 1118 to trigger respective DMA hardware sequencers 1114 to obtain (e.g., receive, acquire, capture, etc.) sensor data from the memory 1108 and store the sensor data in the respective VMEMs 1112. In examples, the PPEs 1118 can process the data stored in the respective VMEMs 1112 and write data back to the VMEMs 1112. In these examples, the data written by the PPEs 1118 into respective VMEMs 1112 can include updated sensor data and/or data generated based at least in part on analysis performed by the PPEs 1118 on the sensor data, including object or feature locations within a frame, a classification indicating a type of an object or agent, and/or the like. In some embodiments, the PPEs 1118 can send a signal to the respective DMA hardware sequencers 1114 to cause the DMA hardware sequencers 1114 to update one or more descriptors (described herein). For example, the PPEs 1118 can send a signal to the respective DMA hardware sequencers 1114 to cause the DMA hardware sequencers 1114 to update one or more descriptors based at least in part on the data written by the PPEs 1118 to the respective VMEMs 1112.

The caches 1120 can include a storage device that is interconnected with the VMEMs 1112 and/or the instruction switch 1106. As noted above, the caches 1120 can receive data associated with instructions from the instruction switches 1106 and load the instructions into one or more devices of the functional blocks 1110 to cause the one or more devices to operate in accordance with the instructions. The DLUTs 1122 can include a processor and/or memory configured to store one or more lookup tables. In some embodiments, the DLUTs 1122 can be configured to enable communication between the processor 1102 and one or more components of the functional blocks 1110. For example, the DLUTs 1122 can be configured to be in communication with the processor 1102 and/or one or more memory devices of FIG. 11 (e.g., the memory 1108 and/or the memory 1104). The DLUT 1122 can then manage the data storage and retrieval process between the processor 1102 and the one or more memory devices of FIG. 11. The DLSUs 1124 can include a storage device that is interconnected with the VMEMs 1112 and PPEs 1118 of a given functional block 1110. For example, the DLSUs 1124 can receive and store the sensor data obtained by the VMEMs 1112 from the memory 1108. Additionally, or alternatively, the DLSUs 1124 can receive and store the data provided as an output by the PPEs 1118.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data and/or map data may be used to identify regions of interest (e.g., parking spaces) and sub-regions of interest (e.g., sub-regions of a parking space that includes a curb, wheel stop, etc.) within the simulation environment, and may use this information to perform operations (e.g., parking) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. The synthetic training data (in addition to or alternatively from real-world data) may then be processed to determine geometry and/or other information related to regions of interest, such as parking spaces or pallet delivery locations within a warehouse, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems-such as systems for testing, validating, training (e.g., machine learning models, neural networks, etc.), and/or other tasks related to automotive, robot, machine, or other applications.

In at least one embodiment, a small language model optimized for at least one target language may be hosted in a cloud environment and made available for use by various persons, entities, systems, operations, and the like. In at least one embodiment, such models can also be provided for deployment and use by various entities on their resources, whether on-premises resources or allocated portions of multitenant physical or virtual resources, among other such options.

In some embodiments, a model may be deployed as part of a software container, such as a NIM from NVIDIA Corporation, which can contain the code and support needed to run inferencing using the model. Such a container may include a set of easy-to-use inference microservices for accelerating the deployment of foundation models on a cloud deployment or data center, and can help to manage security of the request and generated response data. The container can be pre-configured for ease of deployment, and may include one or more optimized inference engines. The container may also include management functionality to handle tasks such as identity management, metric generation, health checks, and status monitoring. As such, in some examples, the machine learning model (small language model) may be packaged as a microservice—such an inference microservice—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model is small enough (e.g., has a small enough number of parameters), the model may be included within the container itself. In other examples—such as where the model is large—the model may be hosted/stored in the cloud (e.g., in a data center) and/or may be hosted on-premises and/or at the edge (e.g., on a local server or computing device, but outside of the container). In such embodiments, the model may be accessible via one or more APIs—such as REST APIs. As such, and in some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medical systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Data Center

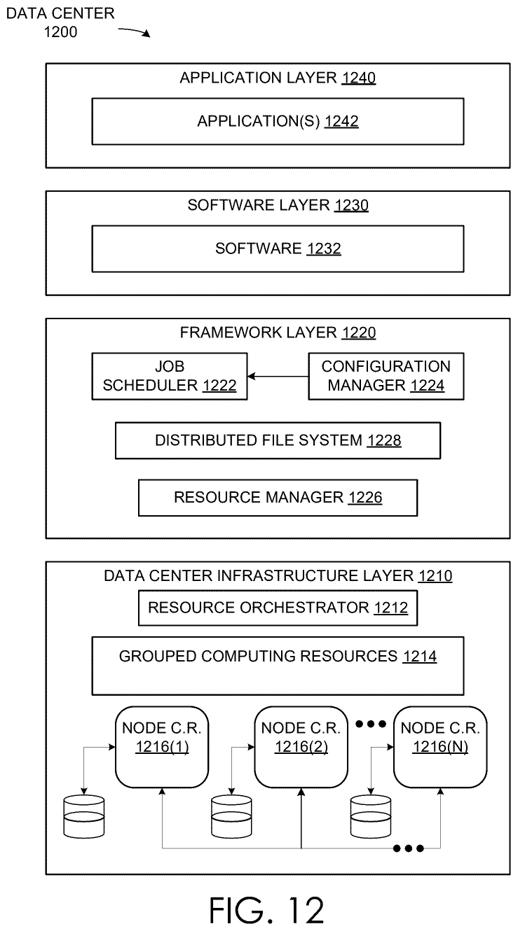

FIG. 12 illustrates an example data center 1200, in which at least one embodiment may be used. In at least one embodiment, data center 1200 includes a data center infrastructure layer 1210, a framework layer 1220, a software layer 1230, and an application layer 1240.

In at least one embodiment, as shown in FIG. 12, data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1216(1)-1216(N) may be a server having one or more of above-mentioned computing resources.

In at least one embodiment, grouped computing resources 1214 may include separate groupings of node C.R.s housed within one or more racks (not shown), or many racks housed in data centers at various geographical locations (also not shown). Separate groupings of node C.R.s within grouped computing resources 1214 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 1212 may configure or otherwise control one or more node C.R.s 1216(1)-1216(N) and/or grouped computing resources 1214. In at least one embodiment, resource orchestrator 1212 may include a software design infrastructure (“SDI”) management entity for data center 1200. In at least one embodiment, resource orchestrator 1212 may include hardware, software or some combination thereof.

In at least one embodiment, as shown in FIG. 12, framework layer 1220 includes a job scheduler 1222, a configuration manager 1224, a resource manager 1226 and a distributed file system 1228. In at least one embodiment, framework layer 1220 may include a framework to support software 1232 of software layer 1230 and/or one or more application(s) 1242 of application layer 1240. In at least one embodiment, software 1232 or application(s) 1242 may respectively include web-based service software or applications, such as those provided by Amazon Web Services, Google Cloud and Microsoft Azure. In at least one embodiment, framework layer 1220 may be, but is not limited to, a type of free and open-source software web application framework such as Apache Spark™ (hereinafter “Spark”) that may use distributed file system 1228 for large-scale data processing (e.g., “big data”). In at least one embodiment, job scheduler 1222 may include a Spark driver to facilitate scheduling of workloads supported by various layers of data center 1200. In at least one embodiment, configuration manager 1224 may be capable of configuring different layers such as software layer 1230 and framework layer 1220 including Spark and distributed file system 1228 for supporting large-scale data processing. In at least one embodiment, resource manager 1226 may be capable of managing clustered or grouped computing resources mapped to or allocated for support of distributed file system 1228 and job scheduler 1222. In at least one embodiment, clustered or grouped computing resources may include grouped computing resource 1214 at data center infrastructure layer 1210. In at least one embodiment, resource manager 1226 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1228 of framework layer 1220. The one or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1228 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1224, resource manager 1226, and resource orchestrator 1212 may implement any number and type of self-modifying actions based on any amount and type of data acquired in any technically feasible fashion. In at least one embodiment, self-modifying actions may relieve a data center operator of data center 1200 from making possibly bad configuration decisions and possibly avoiding underused and/or poor performing portions of a data center.

In at least one embodiment, data center 1200 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1200. In at least one embodiment, trained machine learning models corresponding to one or more neural networks may be used to infer or predict information using resources described above with respect to data center 1200 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used to generate an alternate view image, such as a bird's eye view image, from disparity data using limited capacity hardware, such as an embedded processor without access to external memory.

### Computer Systems

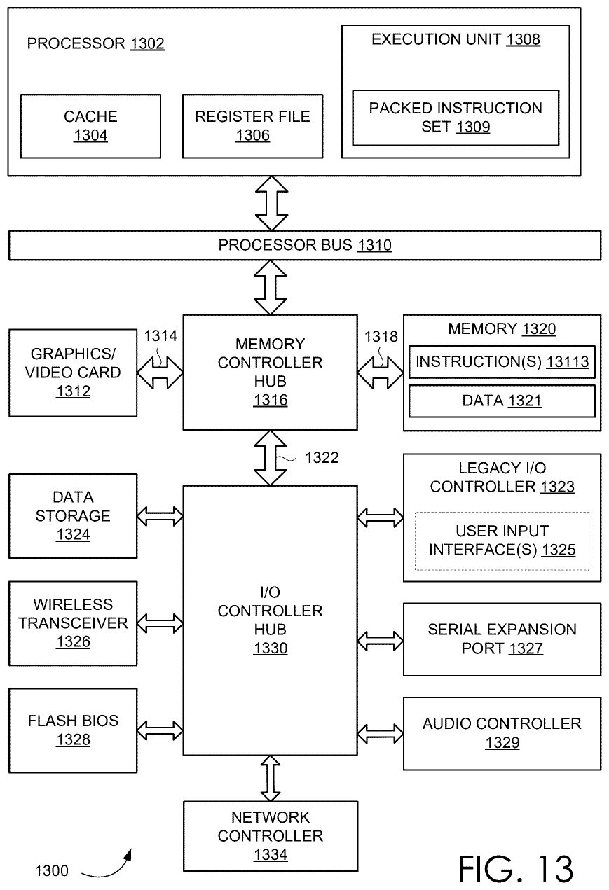

FIG. 13 is a block diagram illustrating an exemplary computer system, which may be a system with interconnected devices and components, a system-on-a-chip (SOC) or some combination thereof 1300 formed with a processor that may include execution units to execute an instruction, according to at least one embodiment. In at least one embodiment, computer system 1300 may include, without limitation, a component, such as a processor 1302 to employ execution units including logic to perform algorithms for process data, in accordance with present disclosure, such as in embodiment described herein. In at least one embodiment, computer system 1300 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1300 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 1300 may include, without limitation, processor 1302 that may include, without limitation, one or more execution units 1308 to perform machine learning model training and/or inferencing according to techniques described herein. In at least one embodiment, computer system 1300 is a single processor desktop or server system, but in another embodiment computer system 1300 may be a multiprocessor system. In at least one embodiment, processor 1302 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 1302 may be coupled to a processor bus 1310 that may transmit data signals between processor 1302 and other components in computer system 1300.

In at least one embodiment, processor 1302 may include, without limitation, a Level 1 (“L1”) internal cache memory (“cache”) 1304. In at least one embodiment, processor 1302 may have a single internal cache or multiple levels of internal cache. In at least one embodiment, cache memory may reside external to processor 1302. Other embodiments may also include a combination of both internal and external caches depending on particular implementation and needs. In at least one embodiment, register file 1306 may store different types of data in various registers including, without limitation, integer registers, floating point registers, status registers, and instruction pointer register.

In at least one embodiment, execution unit 1308, including, without limitation, logic to perform integer and floating point operations, also resides in processor 1302. In at least one embodiment, processor 1302 may also include a microcode (“ucode”) read only memory (“ROM”) that stores microcode for certain macro instructions. In at least one embodiment, execution unit 1308 may include logic to handle a packed instruction set 1309. In at least one embodiment, by including packed instruction set 1309 in an instruction set of a general-purpose processor 1302, along with associated circuitry to execute instructions, operations used by many multimedia applications may be performed using packed data in a general-purpose processor 1302. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 1308 may also be used in microcontrollers, embedded processors, graphics devices, DSPs, and other types of logic circuits. In at least one embodiment, computer system 1300 may include, without limitation, a memory 1320. In at least one embodiment, memory 1320 may be implemented as a Dynamic Random Access Memory (“DRAM”) device, a Static Random Access Memory (“SRAM”) device, flash memory device, or other memory device. In at least one embodiment, memory 1320 may store instruction(s) 1319 and/or data 1321 represented by data signals that may be executed by processor 1302.

In at least one embodiment, system logic chip may be coupled to processor bus 1310 and memory 1320. In at least one embodiment, system logic chip may include, without limitation, a memory controller hub (“MCH”) 1316, and processor 1302 may communicate with MCH 1316 via processor bus 1310. In at least one embodiment, MCH 1316 may provide a high bandwidth memory path 1318 to memory 1320 for instruction and data storage and for storage of graphics commands, data and textures. In at least one embodiment, MCH 1316 may direct data signals between processor 1302, memory 1320, and other components in computer system 1300 and to bridge data signals between processor bus 1310, memory 1320, and a system I/O 1322. In at least one embodiment, system logic chip may provide a graphics port for coupling to a graphics controller. In at least one embodiment, MCH 1316 may be coupled to memory 1320 through a high bandwidth memory path 1318 and graphics/video card 1312 may be coupled to MCH 1316 through an Accelerated Graphics Port (“AGP”) interconnect 1314.

In at least one embodiment, computer system 1300 may use system I/O 1322 that is a proprietary hub interface bus to couple MCH 1316 to I/O controller hub (“ICH”) 1330. In at least one embodiment, ICH 1330 may provide direct connections to some I/O devices via a local I/O bus. In at least one embodiment, local I/O bus may include, without limitation, a high-speed I/O bus for connecting peripherals to memory 1320, chipset, and processor 1302. Examples may include, without limitation, an audio controller 1329, a firmware hub (“flash BIOS”) 1328, a wireless transceiver 1326, a data storage 1324, a legacy I/O controller 1323 containing user input and keyboard interfaces 1325, a serial expansion port 1327, such as Universal Serial Bus (“USB”), and a network controller 1334. Data storage 1324 may comprise a hard disk drive, a floppy disk drive, a CD-ROM device, a flash memory device, or other mass storage device.

In at least one embodiment, FIG. 13 illustrates a system, which includes interconnected hardware devices or “chips”, whereas in other embodiments, FIG. 13 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Such components can be used to generate an alternate view image, such as a bird's eye view image, from disparity data using limited capacity hardware, such as an embedded processor without access to external memory.

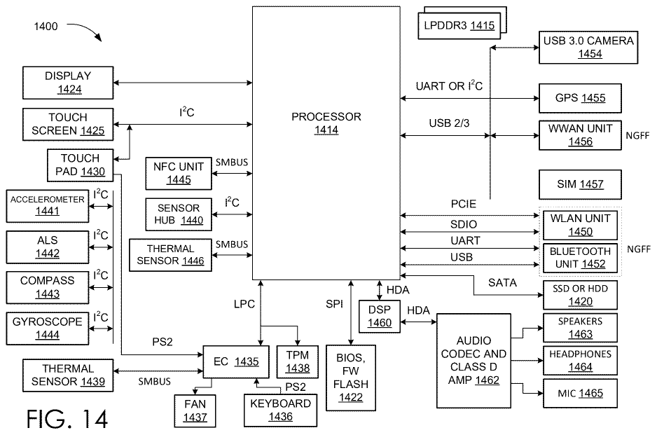

FIG. 14 is a block diagram illustrating an electronic device 1400 for utilizing a processor 1410, according to at least one embodiment. In at least one embodiment, electronic device 1400 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1400 may include, without limitation, processor 1410 communicatively coupled to any suitable number or kind of components, peripherals, modules, or devices. In at least one embodiment, processor 1410 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 14 illustrates a system, which includes interconnected hardware devices or “chips”, whereas in other embodiments, FIG. 14 may illustrate an exemplary System on a Chip (“SoC”). In at least one embodiment, devices illustrated in FIG. 14 may be interconnected with proprietary interconnects, standardized interconnects (e.g., PCIe) or some combination thereof. In at least one embodiment, one or more components of FIG. 14 are interconnected using compute express link (CXL) interconnects.

In at least one embodiment, FIG. 14 may include a display 1424, a touch screen 1425, a touch pad 1430, a Near Field Communications unit (“NFC”) 1445, a sensor hub 1440, a thermal sensor 1446, an Express Chipset (“EC”) 1435, a Trusted Platform Module (“TPM”) 1438, BIOS/firmware/flash memory (“BIOS, FW Flash”) 1422, a DSP 1460, a drive 1420 such as a Solid State Disk (“SSD”) or a Hard Disk Drive (“HDD”), a wireless local area network unit (“WLAN”) 1450, a Bluetooth unit 1452, a Wireless Wide Area Network unit (“WWAN”) 1456, a Global Positioning System (GPS) 1455, a camera (“USB 3.0 camera”) 1454 such as a USB 3.0 camera, and/or a Low Power Double Data Rate (“LPDDR”) memory unit (“LPDDR3”) 1415 implemented in, for example, LPDDR3 standard. These components may each be implemented in any suitable manner.

In at least one embodiment, other components may be communicatively coupled to processor 1410 through components discussed above. In at least one embodiment, an accelerometer 1441, Ambient Light Sensor (“ALS”) 1442, compass 1443, and a gyroscope 1444 may be communicatively coupled to sensor hub 1440. In at least one embodiment, thermal sensor 1439, a fan 1437, a keyboard 1436, and a touch pad 1430 may be communicatively coupled to EC 1435. In at least one embodiment, speakers 1463, headphones 1464, and microphone (“mic”) 1465 may be communicatively coupled to an audio unit (“audio codec and class d amp”) 1462, which may in turn be communicatively coupled to DSP 1460. In at least one embodiment, audio unit 1462 may include, for example and without limitation, an audio coder/decoder (“codec”) and a class D amplifier. In at least one embodiment, SIM card (“SIM”) 1457 may be communicatively coupled to WWAN unit 1456. In at least one embodiment, components such as WLAN unit 1450 and Bluetooth unit 1452, as well as WWAN unit 1456 may be implemented in a Next Generation Form Factor (“NGFF”).

Such components can be used to generate an alternate view image, such as a bird's eye view image, from disparity data using limited capacity hardware, such as an embedded processor without access to external memory.

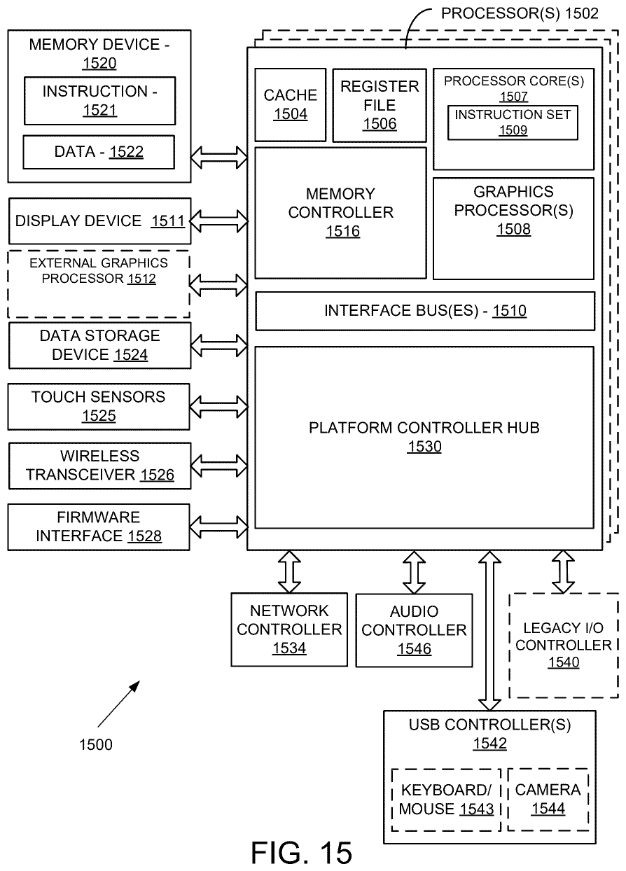

FIG. 15 is a block diagram of a processing system, according to at least one embodiment. In at least one embodiment, system 1500 includes one or more processor(s) 1502 and one or more graphics processor(s) 1508, and may be a single processor desktop system, a multiprocessor workstation system, or a server system having a large number of processor(s) 1502 or processor core(s) 1507. In at least one embodiment, system 1500 is a processing platform incorporated within a system-on-a-chip (SoC) integrated circuit for use in mobile, handheld, or embedded devices.

In at least one embodiment, system 1500 can include, or be incorporated within a server-based gaming platform, a game console, including a game and media console, a mobile gaming console, a handheld game console, or an online game console. In at least one embodiment, system 1500 is a mobile phone, smart phone, tablet computing device or mobile Internet device. In at least one embodiment, processing system 1500 can also include, coupled with, or be integrated within a wearable device, such as a smart watch wearable device, smart eyewear device, augmented reality device, or virtual reality device. In at least one embodiment, processing system 1500 is a television or set top box device having one or more processor(s) 1502 and a graphical interface generated by one or more graphics processor(s) 1508.

In at least one embodiment, one or more processor(s) 1502 each include one or more processor core(s) 1507 to process instructions which, when executed, perform operations for system and user software. In at least one embodiment, each of one or more processor core(s) 1507 is configured to process a specific instruction set 1509. In at least one embodiment, instruction set 1509 may facilitate Complex Instruction Set Computing (CISC), Reduced Instruction Set Computing (RISC), or computing via a Very Long Instruction Word (VLIW). In at least one embodiment, processor core(s) 1507 may each process a different instruction set 1509, which may include instructions to facilitate emulation of other instruction sets. In at least one embodiment, processor core(s) 1507 may also include other processing devices, such a Digital Signal Processor (DSP).

In at least one embodiment, processor(s) 1502 includes cache memory 1504. In at least one embodiment, processor(s) 1502 can have a single internal cache or multiple levels of internal cache. In at least one embodiment, cache memory is shared among various components of processor(s) 1502. In at least one embodiment, processor(s) 1502 also uses an external cache (e.g., a Level-3 (L3) cache or Last Level Cache (LLC)) (not shown), which may be shared among processor core(s) 1507 using known cache coherency techniques. In at least one embodiment, register file 1506 is additionally included in processor(s) 1502 which may include different types of registers for storing different types of data (e.g., integer registers, floating point registers, status registers, and an instruction pointer register). In at least one embodiment, register file 1506 may include general-purpose registers or other registers.

In at least one embodiment, one or more processor(s) 1502 are coupled with one or more interface bus(es) 1510 to transmit communication signals such as address, data, or control signals between processor(s) 1502 and other components in system 1500. In at least one embodiment, interface bus(es) 1510, in one embodiment, can be a processor bus, such as a version of a Direct Media Interface (DMI) bus. In at least one embodiment, interface bus(es) 1510 is not limited to a DMI bus, and may include one or more Peripheral Component Interconnect buses (e.g., PCI, PCI Express), memory busses, or other types of interface busses. In at least one embodiment processor(s) 1502 include an integrated memory controller 1516 and a platform controller hub 1530. In at least one embodiment, memory controller 1516 facilitates communication between a memory device and other components of system 1500, while platform controller hub (PCH) 1530 provides connections to I/O devices via a local I/O bus.

In at least one embodiment, memory device 1520 can be a dynamic random access memory (DRAM) device, a static random access memory (SRAM) device, flash memory device, phase-change memory device, or some other memory device having suitable performance to serve as process memory. In at least one embodiment memory device 1520 can operate as system memory for system 1500, to store data 1522 and instruction 1521 for use when one or more processor(s) 1502 executes an application or process. In at least one embodiment, memory controller 1516 also couples with an optional external graphics processor 1512, which may communicate with one or more graphics processor(s) 1508 in processor(s) 1502 to perform graphics and media operations. In at least one embodiment, a display device 1511 can connect to processor(s) 1502. In at least one embodiment display device 1511 can include one or more of an internal display device, as in a mobile electronic device or a laptop device or an external display device attached via a display interface (e.g., DisplayPort, etc.). In at least one embodiment, display device 1511 can include a head mounted display (HMD) such as a stereoscopic display device for use in virtual reality (VR) applications or augmented reality (AR) applications.

In at least one embodiment, platform controller hub 1530 enables peripherals to connect to memory device 1520 and processor(s) 1502 via a high-speed I/O bus. In at least one embodiment, I/O peripherals include, but are not limited to, an audio controller 1546, a network controller 1534, a firmware interface 1528, a wireless transceiver 1526, touch sensors 1525, a data storage device 1524 (e.g., hard disk drive, flash memory, etc.). In at least one embodiment, data storage device 1524 can connect via a storage interface (e.g., SATA) or via a peripheral bus, such as a Peripheral Component Interconnect bus (e.g., PCI, PCI Express). In at least one embodiment, touch sensors 1525 can include touch screen sensors, pressure sensors, or fingerprint sensors. In at least one embodiment, wireless transceiver 1526 can be a Wi-Fi transceiver, a Bluetooth transceiver, or a mobile network transceiver such as a 3G, 4G, or Long Term Evolution (LTE) transceiver. In at least one embodiment, firmware interface 1528 enables communication with system firmware, and can be, for example, a unified extensible firmware interface (UEFI). In at least one embodiment, network controller 1534 can enable a network connection to a wired network. In at least one embodiment, a high-performance network controller (not shown) couples with interface bus(es) 1510. In at least one embodiment, audio controller 1546 is a multi-channel high definition audio controller. In at least one embodiment, system 1500 includes an optional legacy I/O controller 1540 for coupling legacy (e.g., Personal System 2 (PS/2)) devices to system. In at least one embodiment, platform controller hub 1530 can also connect to one or more Universal Serial Bus (USB) controller(s) 1542 connect input devices, such as keyboard and mouse 1543 combinations, a camera 1544, or other USB input devices.

In at least one embodiment, an instance of memory controller 1516 and platform controller hub 1530 may be integrated into a discreet external graphics processor, such as external graphics processor 1512. In at least one embodiment, platform controller hub 1530 and/or memory controller 1516 may be external to one or more processor(s) 1502. For example, in at least one embodiment, system 1500 can include an external memory controller 1516 and platform controller hub 1530, which may be configured as a memory controller hub and peripheral controller hub within a system chipset that is in communication with processor(s) 1502.

Such components can be used to generate an alternate view image, such as a bird's eye view image, from disparity data using limited capacity hardware, such as an embedded processor without access to external memory.

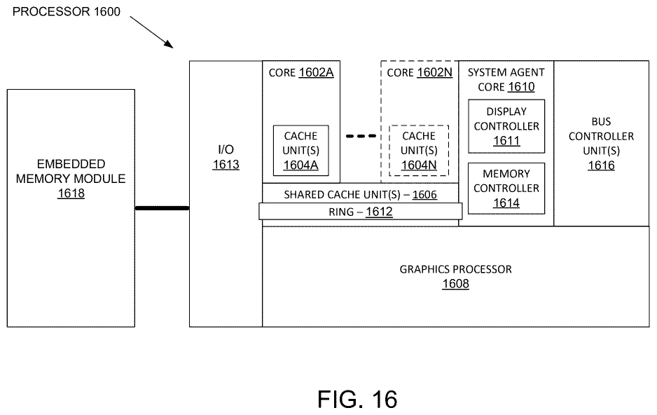

FIG. 16 is a block diagram of a processor 1600 having one or more processor core(s) 1602A-1602N, an integrated memory controller 1614, and an integrated graphics processor 1608, according to at least one embodiment. In at least one embodiment, processor 1600 can include additional cores up to and including additional core 1602N represented by dashed lined boxes. In at least one embodiment, each of processor core(s) 1602A-1602N includes one or more internal cache unit(s) 1604A-1604N. In at least one embodiment, each processor core also has access to one or more shared cached unit(s) 1606.

In at least one embodiment, internal cache unit(s) 1604A-1604N and shared cache unit(s) 1606 represent a cache memory hierarchy within processor 1600. In at least one embodiment, cache unit(s) 1604A-1604N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1606 and 1604A-1604N.

In at least one embodiment, processor 1600 may also include a set of one or more bus controller unit(s) 1616 and a system agent core 1610. In at least one embodiment, one or more bus controller unit(s) 1616 manage a set of peripheral buses, such as one or more PCI or PCI express busses. In at least one embodiment, system agent core 1610 provides management functionality for various processor components. In at least one embodiment, system agent core 1610 includes one or more integrated memory controllers 1614 to manage access to various external memory devices (not shown).

In at least one embodiment, one or more of processor core(s) 1602A-1602N include support for simultaneous multi-threading. In at least one embodiment, system agent core 1610 includes components for coordinating and processor core(s) 1602A-1602N during multi-threaded processing. In at least one embodiment, system agent core 1610 may additionally include a power control unit (PCU), which includes logic and components to regulate one or more power states of processor core(s) 1602A-1602N and graphics processor 1608.

In at least one embodiment, processor 1600 additionally includes graphics processor 1608 to execute graphics processing operations. In at least one embodiment, graphics processor 1608 couples with shared cache unit(s) 1606, and system agent core 1610, including one or more integrated memory controllers 1614. In at least one embodiment, system agent core 1610 also includes a display controller 1611 to drive graphics processor output to one or more coupled displays. In at least one embodiment, display controller 1611 may also be a separate module coupled with graphics processor 1608 via at least one interconnect, or may be integrated within graphics processor 1608.

In at least one embodiment, a ring based interconnect unit 1612 is used to couple internal components of processor 1600. In at least one embodiment, an alternative interconnect unit may be used, such as a point-to-point interconnect, a switched interconnect, or other techniques. In at least one embodiment, graphics processor 1608 couples with a ring based interconnect unit 1612 via an I/O link 1613.

In at least one embodiment, I/O link 1613 represents at least one of multiple varieties of I/O interconnects, including an on package I/O interconnect which facilitates communication between various processor components and a high-performance embedded memory module 1618, such as an eDRAM module. In at least one embodiment, each of processor core(s) 1602A-1602N and graphics processor 1608 use embedded memory modules 1618 as a shared Last Level Cache.

In at least one embodiment, processor core(s) 1602A-1602N are homogenous cores executing a common instruction set architecture. In at least one embodiment, processor core(s) 1602A-1602N are heterogeneous in terms of instruction set architecture (ISA), where one or more of processor core(s) 1602A-1602N execute a common instruction set, while one or more other cores of processor core(s) 1602A-1602N executes a subset of a common instruction set or a different instruction set. In at least one embodiment, processor core(s) 1602A-1602N are heterogeneous in terms of microarchitecture, where one or more cores having a relatively higher power consumption couple with one or more power cores having a lower power consumption. In at least one embodiment, processor 1600 can be implemented on one or more chips or as an SoC integrated circuit.

Such components can be used to generate an alternate view image, such as a bird's eye view image, from disparity data using limited capacity hardware, such as an embedded processor without access to external memory.

### Autonomous Vehicle

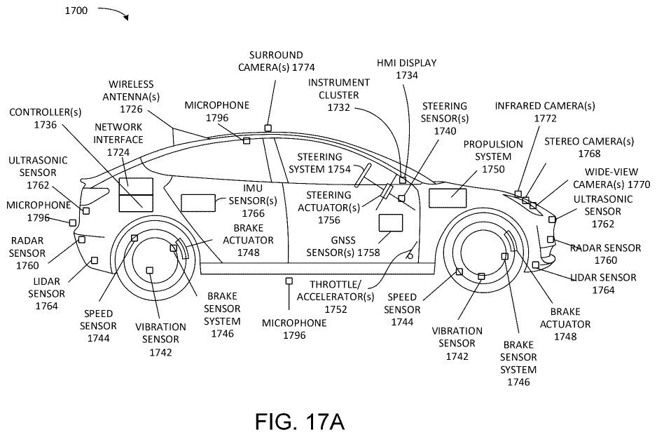

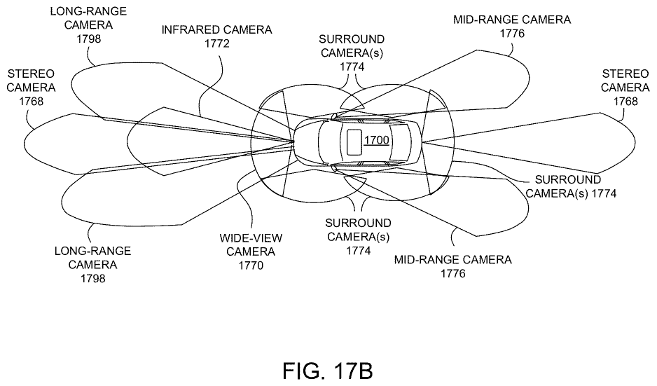

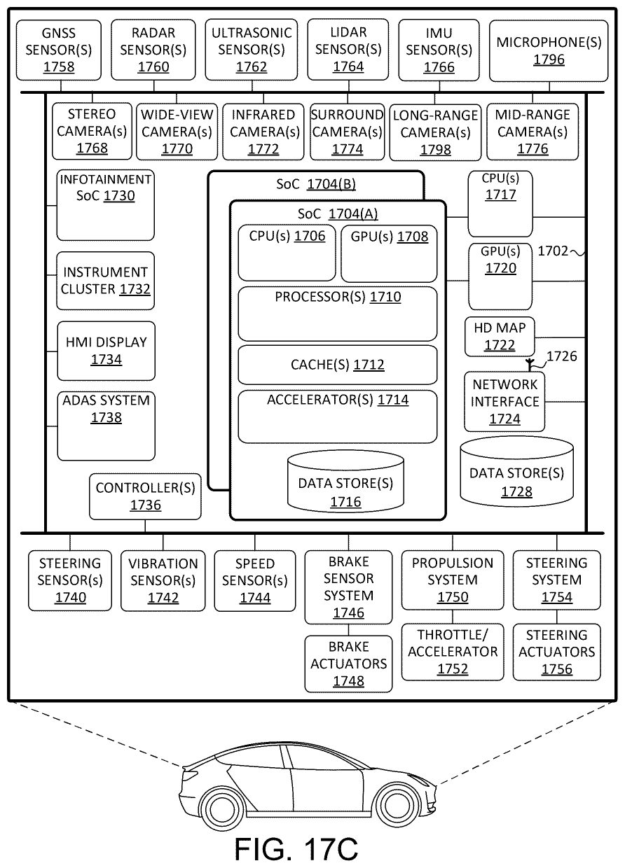

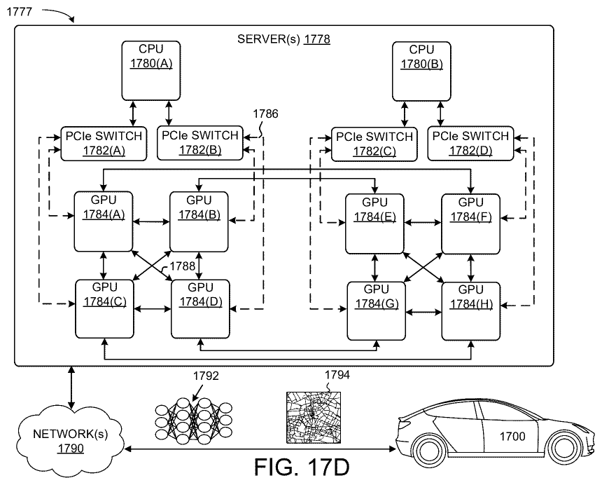

FIG. 17A illustrates an example of an autonomous vehicle 1700, according to at least one embodiment. In at least one embodiment, autonomous vehicle 1700 (alternatively referred to herein as “vehicle 1700”) may be, without limitation, a passenger vehicle, such as a car, a truck, a bus, and/or another type of vehicle that accommodates one or more passengers. In at least one embodiment, vehicle 1700 may be a semi-tractor-trailer truck used for hauling cargo. In at least one embodiment, vehicle 1700 may be an airplane, robotic vehicle, or other kind of vehicle.

Autonomous vehicles may be described in terms of automation levels, defined by National Highway Traffic Safety Administration (“NHTSA”), a division of US Department of Transportation, and Society of Automotive Engineers (“SAE”) “Taxonomy and Definitions for Terms Related to Driving Automation Systems for On-Road Motor Vehicles” (e.g., Standard No. J3016-201806, published on Jun. 15, 2018, Standard No. J3016-201609, published on Sep. 30, 2016, and previous and future versions of this standard). In at least one embodiment, vehicle 1700 may be capable of functionality in accordance with one or more of Level 1 through Level 5 of autonomous driving levels. For example, in at least one embodiment, vehicle 1700 may be capable of conditional automation (Level 3), high automation (Level 4), and/or full automation (Level 5), depending on embodiment.

In at least one embodiment, vehicle 1700 may include, without limitation, components such as a chassis, a vehicle body, wheels (e.g., 2, 4, 6, 8, 18, etc.), tires, axles, and other components of a vehicle. In at least one embodiment, vehicle 1700 may include, without limitation, a propulsion system 1750, such as an internal combustion engine, hybrid electric power plant, an all-electric engine, and/or another propulsion system type. In at least one embodiment, propulsion system 1750 may be connected to a drive train of vehicle 1700, which may include, without limitation, a transmission, to enable propulsion of vehicle 1700. In at least one embodiment, propulsion system 1750 may be controlled in response to receiving signals from a throttle/accelerator(s) 1752.

In at least one embodiment, a steering system 1754, which may include, without limitation, a steering wheel, is used to steer vehicle 1700 (e.g., along a desired path or route) when propulsion system 1750 is operating (e.g., when vehicle 1700 is in motion). In at least one embodiment, steering system 1754 may receive signals from steering actuator(s) 1756. In at least one embodiment, a steering wheel may be optional for full automation (Level 5) functionality. In at least one embodiment, a brake sensor system 1746 may be used to operate vehicle brakes in response to receiving signals from brake actuator(s) 1748 and/or brake sensors.

In at least one embodiment, controller(s) 1736, which may include, without limitation, one or more system on chips (“SoCs”) (not shown in FIG. 17A) and/or graphics processing unit(s) (“GPU(s)”), provide signals (e.g., representative of commands) to one or more components and/or systems of vehicle 1700. For instance, in at least one embodiment, controller(s) 1736 may send signals to operate vehicle brakes via brake actuator(s) 1748, to operate steering system 1754 via steering actuator(s) 1756, to operate propulsion system 1750 via throttle/accelerator(s) 1752. In at least one embodiment, controller(s) 1736 may include one or more onboard (e.g., integrated) computing devices that process sensor signals, and output operation commands (e.g., signals representing commands) to enable autonomous driving and/or to assist a human driver in driving vehicle 1700. In at least one embodiment, controller(s) 1736 may include a first controller for autonomous driving functions, a second controller for functional safety functions, a third controller for artificial intelligence functionality (e.g., computer vision), a fourth controller for infotainment functionality, a fifth controller for redundancy in emergency conditions, and/or other controllers. In at least one embodiment, a single controller may handle two or more of above functionalities, two or more controllers may handle a single functionality, and/or any combination thereof.

In at least one embodiment, controller(s) 1736 provide signals for controlling one or more components and/or systems of vehicle 1700 in response to sensor data received from one or more sensors (e.g., sensor inputs). In at least one embodiment, sensor data may be received from, for example and without limitation, global navigation satellite systems (“GNSS”) sensor(s) 1758 (e.g., Global Positioning System sensor(s)), RADAR sensor(s) 1760, ultrasonic sensor(s) 1762, LIDAR sensor(s) 1764, inertial measurement unit (“IMU”) sensor(s) 1766 (e.g., accelerometer(s), gyroscope(s), a magnetic compass or magnetic compasses, magnetometer(s), etc.), microphone(s) 1796, stereo camera(s) 1768, wide-view camera(s) 1770 (e.g., fisheye cameras), infrared camera(s) 1772, surround camera(s) 1774 (e.g., 360 degree cameras), long-range cameras (not shown in FIG. 17A), mid-range camera(s) (not shown in FIG. 17A), speed sensor(s) 1744 (e.g., for measuring speed of vehicle 1700), vibration sensor(s) 1742, steering sensor(s) 1740, brake sensor(s) (e.g., as part of brake sensor system 1746), and/or other sensor types.

In at least one embodiment, one or more of controller(s) 1736 may receive inputs (e.g., represented by input data) from an instrument cluster 1732 of vehicle 1700 and provide outputs (e.g., represented by output data, display data, etc.) via a human-machine interface (“HMI”) display 1734, an audible annunciator, a loudspeaker, and/or via other components of vehicle 1700. In at least one embodiment, outputs may include information such as vehicle velocity, speed, time, map data (e.g., a High Definition map (not shown in FIG. 17A)), location data (e.g., vehicle's 1700 location, such as on a map), direction, location of other vehicles (e.g., an occupancy grid), information about objects and status of objects as perceived by controller(s) 1736, etc. For example, in at least one embodiment, HMI display 1734 may display information about presence of one or more objects (e.g., a street sign, caution sign, traffic light changing, etc.), and/or information about driving maneuvers vehicle has made, is making, or will make (e.g., changing lanes now, taking exit 34B in two miles, etc.).

In at least one embodiment, vehicle 1700 further includes a network interface 1724 which may use wireless antenna(s) 1726 and/or modem(s) to communicate over one or more networks. For example, in at least one embodiment, network interface 1724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”) networks, etc. In at least one embodiment, wireless antenna(s) 1726 may also enable communication between objects in environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc. protocols.

Such components can be used to generate an alternate view image, such as a bird's eye view image, from disparity data using limited capacity hardware, such as an embedded processor without access to external memory.

FIG. 17B illustrates an example of camera locations and fields of view for autonomous vehicle 1700 of FIG. 17A, according to at least one embodiment. In at least one embodiment, cameras and respective fields of view are one example embodiment and are not intended to be limiting. For instance, in at least one embodiment, additional and/or alternative cameras may be included and/or cameras may be located at different locations on vehicle 1700.

In at least one embodiment, camera types for cameras may include, but are not limited to, digital cameras that may be adapted for use with components and/or systems of vehicle 1700. In at least one embodiment, camera(s) may operate at automotive safety integrity level (“ASIL”) B and/or at another ASIL. In at least one embodiment, camera types may be capable of any image capture rate, such as 60 frames per second (fps), 1220 fps, 240 fps, etc., depending on embodiment. In at least one embodiment, cameras may be capable of using rolling shutters, global shutters, another type of shutter, or a combination thereof. In at least one embodiment, color filter array may include a red clear clear clear (“RCCC”) color filter array, a red clear clear blue (“RCCB”) color filter array, a red blue green clear (“RBGC”) color filter array, a Foveon X3 color filter array, a Bayer sensors (“RGGB”) color filter array, a monochrome sensor color filter array, and/or another type of color filter array. In at least one embodiment, clear pixel cameras, such as cameras with an RCCC, an RCCB, and/or an RBGC color filter array, may be used in an effort to increase light sensitivity.

In at least one embodiment, one or more of camera(s) may be used to perform advanced driver assistance systems (“ADAS”) functions (e.g., as part of a redundant or fail-safe design). For example, in at least one embodiment, a Multi-Function Mono Camera may be installed to provide functions including lane departure warning, traffic sign assist and intelligent headlamp control. In at least one embodiment, one or more of camera(s) (e.g., all cameras) may record and provide image data (e.g., video) simultaneously.

In at least one embodiment, one or more camera may be mounted in a mounting assembly, such as a custom designed (three-dimensional (“3D”) printed) assembly, in order to cut out stray light and reflections from within vehicle 1700 (e.g., reflections from dashboard reflected in windshield mirrors) which may interfere with camera image data capture abilities. With reference to wing-mirror mounting assemblies, in at least one embodiment, wing-mirror assemblies may be custom 3D printed so that a camera mounting plate matches a shape of a wing-mirror. In at least one embodiment, camera(s) may be integrated into wing-mirrors. In at least one embodiment, for side-view cameras, camera(s) may also be integrated within four pillars at each corner of a cabin.

In at least one embodiment, cameras with a field of view that include portions of an environment in front of vehicle 1700 (e.g., front-facing cameras) may be used for surround view, to help identify forward facing paths and obstacles, as well as aid in, with help of one or more of controller(s) 1736 and/or control SoCs, providing information critical to generating an occupancy grid and/or determining preferred vehicle paths. In at least one embodiment, front-facing cameras may be used to perform many similar ADAS functions as LIDAR, including, without limitation, emergency braking, pedestrian detection, and collision avoidance. In at least one embodiment, front-facing cameras may also be used for ADAS functions and systems including, without limitation, Lane Departure Warnings (“LDW”), Autonomous Cruise Control (“ACC”), and/or other functions such as traffic sign recognition.

In at least one embodiment, a variety of cameras may be used in a front-facing configuration, including, for example, a monocular camera platform that includes a CMOS (“complementary metal oxide semiconductor”) color imager. In at least one embodiment, a wide-view camera 1770 may be used to perceive objects coming into view from a periphery (e.g., pedestrians, crossing traffic or bicycles). Although only one wide-view camera 1770 is illustrated in FIG. 17B, in other embodiments, there may be any number (including zero) wide-view cameras on vehicle 1700. In at least one embodiment, any number of long-range camera(s) 1798 (e.g., a long-view stereo camera pair) may be used for depth-based object detection, especially for objects for which a neural network has not yet been trained. In at least one embodiment, long-range camera(s) 1798 may also be used for object detection and classification, as well as basic object tracking.

In at least one embodiment, any number of stereo camera(s) 1768 may also be included in a front-facing configuration. In at least one embodiment, one or more of stereo camera(s) 1768 may include an integrated control unit comprising a scalable processing unit, which may provide a programmable logic (“FPGA”) and a multi-core micro-processor with an integrated Controller Area Network (“CAN”) or Ethernet interface on a single chip. In at least one embodiment, such a unit may be used to generate a 3D map of an environment of vehicle 1700, including a distance estimate for all points in an image. In at least one embodiment, one or more of stereo camera(s) 1768 may include, without limitation, compact stereo vision sensor(s) that may include, without limitation, two camera lenses (one each on left and right) and an image processing chip that may measure distance from vehicle 1700 to target object and use generated information (e.g., metadata) to activate autonomous emergency braking and lane departure warning functions. In at least one embodiment, other types of stereo camera(s) 1768 may be used in addition to, or alternatively from, those described herein.

In at least one embodiment, cameras with a field of view that include portions of environment to sides of vehicle 1700 (e.g., side-view cameras) may be used for surround view, providing information used to create and update an occupancy grid, as well as to generate side impact collision warnings. For example, in at least one embodiment, surround camera(s) 1774 (e.g., four surround cameras as illustrated in FIG. 17B) could be positioned on vehicle 1700. In at least one embodiment, surround camera(s) 1774 may include, without limitation, any number and combination of wide-view cameras, fisheye camera(s), 360 degree camera(s), and/or similar cameras. For instance, in at least one embodiment, four fisheye cameras may be positioned on a front, a rear, and sides of vehicle 1700. In at least one embodiment, vehicle 1700 may use three surround camera(s) 1774 (e.g., left, right, and rear), and may leverage one or more other camera(s) (e.g., a forward-facing camera) as a fourth surround-view camera.

In at least one embodiment, cameras with a field of view that include portions of an environment behind vehicle 1700 (e.g., rear-view cameras) may be used for parking assistance, surround view, rear collision warnings, and creating and updating an occupancy grid. In at least one embodiment, a wide variety of cameras may be used including, but not limited to, cameras that are also suitable as a front-facing camera(s) (e.g., long-range cameras 1798 and/or mid-range camera(s) 1776, stereo camera(s) 1768, infrared camera(s) 1772, etc.) as described herein.

Such components can be used to generate an alternate view image, such as a bird's eye view image, from disparity data using limited capacity hardware, such as an embedded processor without access to external memory.

FIG. 17C is a block diagram illustrating an example system architecture for autonomous vehicle 1700 of FIG. 17A, according to at least one embodiment. In at least one embodiment, each of components, features, and systems of vehicle 1700 in FIG. 17C is illustrated as being connected via a bus 1702. In at least one embodiment, bus 1702 may include, without limitation, a CAN data interface (alternatively referred to herein as a “CAN bus”). In at least one embodiment, a CAN may be a network inside vehicle 1700 used to aid in control of various features and functionality of vehicle 1700, such as actuation of brakes, acceleration, braking, steering, windshield wipers, etc. In at least one embodiment, bus 1702 may be configured to have dozens or even hundreds of nodes, each with its own unique identifier (e.g., a CAN ID). In at least one embodiment, bus 1702 may be read to find steering wheel angle, ground speed, engine revolutions per minute (“RPMs”), button positions, and/or other vehicle status indicators. In at least one embodiment, bus 1702 may be a CAN bus that is ASIL B compliant.

In at least one embodiment, in addition to, or alternatively from CAN, FlexRay and/or Ethernet protocols may be used. In at least one embodiment, there may be any number of busses forming bus 1702, which may include, without limitation, zero or more CAN busses, zero or more FlexRay busses, zero or more Ethernet busses, and/or zero or more other types of busses using different protocols. In at least one embodiment, two or more busses may be used to perform different functions, and/or may be used for redundancy. For example, a first bus may be used for collision avoidance functionality and a second bus may be used for actuation control. In at least one embodiment, each bus of bus 1702 may communicate with any of components of vehicle 1700, and two or more busses of bus 1702 may communicate with corresponding components. In at least one embodiment, each of any number of system(s) on chip(s) (“SoC(s)”) 1704 (such as SoC 1704(A) and SoC 1704(B)), each of controller(s) 1736, and/or each computer within vehicle may have access to same input data (e.g., inputs from sensors of vehicle 1700), and may be connected to a common bus, such CAN bus.

In at least one embodiment, vehicle 1700 may include one or more controller(s) 1736, such as those described herein with respect to FIG. 17A. In at least one embodiment, controller(s) 1736 may be used for a variety of functions. In at least one embodiment, controller(s) 1736 may be coupled to any of various other components and systems of vehicle 1700, and may be used for control of vehicle 1700, artificial intelligence of vehicle 1700, infotainment for vehicle 1700, and/or other functions.

In at least one embodiment, vehicle 1700 may include any number of SoCs 1704. In at least one embodiment, each of SoCs 1704 may include, without limitation, central processing units (“CPU(s)”) 1706, graphics processing units (“GPU(s)”) 1708, processor(s) 1710, cache(s) 1712, accelerator(s) 1714, data store(s) 1716, and/or other components and features not illustrated. In at least one embodiment, SoC(s) 1704 may be used to control vehicle 1700 in a variety of platforms and systems. For example, in at least one embodiment, SoC(s) 1704 may be combined in a system (e.g., system of vehicle 1700) with a High Definition (“HD”) map 1722 which may obtain map refreshes and/or updates via network interface 1724 from one or more servers (not shown in FIG. 17C).

In at least one embodiment, CPU(s) 1706 may include a CPU cluster or CPU complex (alternatively referred to herein as a “CCPLEX”). In at least one embodiment, CPU(s) 1706 may include multiple cores and/or level two (“L2”) caches. For instance, in at least one embodiment, CPU(s) 1706 may include eight cores in a coherent multi-processor configuration. In at least one embodiment, CPU(s) 1706 may include four dual-core clusters where each cluster has a dedicated L2 cache (e.g., a 2 megabyte (MB) L2 cache). In at least one embodiment, CPU(s) 1706 (e.g., CCPLEX) may be configured to support simultaneous cluster operations enabling any combination of clusters of CPU(s) 1706 to be active at any given time.

In at least one embodiment, one or more of CPU(s) 1706 may implement power management capabilities that include, without limitation, one or more of following features: individual hardware blocks may be clock-gated automatically when idle to save dynamic power; each core clock may be gated when such core is not actively executing instructions due to execution of Wait for Interrupt (“WFI”)/Wait for Event (“WFE”) instructions; each core may be independently power-gated; each core cluster may be independently clock-gated when all cores are clock-gated or power-gated; and/or each core cluster may be independently power-gated when all cores are power-gated. In at least one embodiment, CPU(s) 1706 may further implement an enhanced algorithm for managing power states, where allowed power states and expected wakeup times are specified, and hardware/microcode determines which best power state to enter for core, cluster, and CCPLEX. In at least one embodiment, processing cores may support simplified power state entry sequences in software with work offloaded to microcode.

In at least one embodiment, GPU(s) 1708 may include an integrated GPU (alternatively referred to herein as an “iGPU”). In at least one embodiment, GPU(s) 1708 may be programmable and may be efficient for parallel workloads. In at least one embodiment, GPU(s) 1708 may use an enhanced tensor instruction set. In at least one embodiment, GPU(s) 1708 may include one or more streaming microprocessors, where each streaming microprocessor may include a level one (“L1”) cache (e.g., an L1 cache with at least 96 KB storage capacity), and two or more streaming microprocessors may share an L2 cache (e.g., an L2 cache with a 512 KB storage capacity). In at least one embodiment, GPU(s) 1708 may include at least eight streaming microprocessors. In at least one embodiment, GPU(s) 1708 may use compute application programming interface(s) (API(s)). In at least one embodiment, GPU(s) 1708 may use one or more parallel computing platforms and/or programming models (e.g., NVIDIA's CUDA model).

In at least one embodiment, one or more of GPU(s) 1708 may be power-optimized for best performance in automotive and embedded use cases. For example, in at least one embodiment, GPU(s) 1708 could be fabricated on Fin field-effect transistor (“FinFET”) circuitry. In at least one embodiment, each streaming microprocessor may incorporate a number of mixed-precision processing cores partitioned into multiple blocks. For example, and without limitation, 64 PF32 cores and 32 PF64 cores could be partitioned into four processing blocks. In at least one embodiment, each processing block could be allocated 16 FP32 cores, 8 FP64 cores, 16 INT32 cores, two mixed-precision NVIDIA Tensor cores for deep learning matrix arithmetic, a level zero (“L0”) instruction cache, a scheduler (e.g., warp scheduler) or sequencer, a dispatch unit, and/or a 64 KB register file. In at least one embodiment, streaming microprocessors may include independent parallel integer and floating-point data paths to provide for efficient execution of workloads with a mix of computation and addressing calculations. In at least one embodiment, streaming microprocessors may include independent thread scheduling capability to enable finer-grain synchronization and cooperation between parallel threads. In at least one embodiment, streaming microprocessors may include a combined L1 data cache and shared memory unit in order to improve performance while simplifying programming.

In at least one embodiment, one or more of GPU(s) 1708 may include a high bandwidth memory (“HBM”) and/or a 16 GB HBM2 memory subsystem to provide, in some examples, about 900 GB/second peak memory bandwidth. In at least one embodiment, in addition to, or alternatively from, HBM memory, a synchronous graphics random-access memory (“SGRAM”) may be used, such as a graphics double data rate type five synchronous random-access memory (“GDDR5”).

In at least one embodiment, GPU(s) 1708 may include unified memory technology. In at least one embodiment, address translation services (“ATS”) support may be used to allow GPU(s) 1708 to access CPU(s) 1706 page tables directly. In at least one embodiment, embodiment, when a GPU of GPU(s) 1708 memory management unit (“MMU”) experiences a miss, an address translation request may be transmitted to CPU(s) 1706. In response, 2 CPU of CPU(s) 1706 may look in its page tables for a virtual-to-physical mapping for an address and transmit translation back to GPU(s) 1708, in at least one embodiment. In at least one embodiment, unified memory technology may allow a single unified virtual address space for memory of both CPU(s) 1706 and GPU(s) 1708, thereby simplifying GPU(s) 1708 programming and porting of applications to GPU(s) 1708.

In at least one embodiment, GPU(s) 1708 may include any number of access counters that may keep track of frequency of access of GPU(s) 1708 to memory of other processors. In at least one embodiment, access counter(s) may help ensure that memory pages are moved to physical memory of a processor that is accessing pages most frequently, thereby improving efficiency for memory ranges shared between processors.

In at least one embodiment, one or more of SoC(s) 1704 may include any number of cache(s) 1712, including those described herein. For example, in at least one embodiment, cache(s) 1712 could include a level three (“L3”) cache that is available to both CPU(s) 1706 and GPU(s) 1708 (e.g., that is connected to CPU(s) 1706 and GPU(s) 1708). In at least one embodiment, cache(s) 1712 may include a write-back cache that may keep track of states of lines, such as by using a cache coherence protocol (e.g., MEI, MESI, MSI, etc.). In at least one embodiment, a L3 cache may include 4 MB of memory or more, depending on embodiment, although smaller cache sizes may be used.

In at least one embodiment, one or more of SoC(s) 1704 may include one or more accelerator(s) 1714 (e.g., hardware accelerators, software accelerators, or a combination thereof). In at least one embodiment, SoC(s) 1704 may include a hardware acceleration cluster that may include optimized hardware accelerators and/or large on-chip memory. In at least one embodiment, large on-chip memory (e.g., 4 MB of SRAM), may enable a hardware acceleration cluster to accelerate neural networks and other calculations. In at least one embodiment, a hardware acceleration cluster may be used to complement GPU(s) 1708 and to off-load some of tasks of GPU(s) 1708 (e.g., to free up more cycles of GPU(s) 1708 for performing other tasks). In at least one embodiment, accelerator(s) 1714 could be used for targeted workloads (e.g., perception, convolutional neural networks (“CNNs”), recurrent neural networks (“RNNs”), etc.) that are stable enough to be amenable to acceleration. In at least one embodiment, a CNN may include a region-based or regional convolutional neural networks (“RCNNs”) and Fast RCNNs (e.g., as used for object detection) or other type of CNN.

In at least one embodiment, accelerator(s) 1714 (e.g., hardware acceleration cluster) may include one or more deep learning accelerator (“DLA”). In at least one embodiment, DLA(s) may include, without limitation, one or more Tensor processing units (“TPUs”) that may be configured to provide an additional ten trillion operations per second for deep learning applications and inferencing. In at least one embodiment, TPUs may be accelerators configured to, and optimized for, performing image processing functions (e.g., for CNNs, RCNNs, etc.). In at least one embodiment, DLA(s) may further be optimized for a specific set of neural network types and floating point operations, as well as inferencing. In at least one embodiment, design of DLA(s) may provide more performance per millimeter than a typical general-purpose GPU, and typically vastly exceeds performance of a CPU. In at least one embodiment, TPU(s) may perform several functions, including a single-instance convolution function, supporting, for example, INT8, INT16, and FP16 data types for both features and weights, as well as post-processor functions. In at least one embodiment, DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

In at least one embodiment, DLA(s) may perform any function of GPU(s) 1708, and by using an inference accelerator, for example, a designer may target either DLA(s) or GPU(s) 1708 for any function. For example, in at least one embodiment, a designer may focus processing of CNNs and floating point operations on DLA(s) and leave other functions to GPU(s) 1708 and/or accelerator(s) 1714.

In at least one embodiment, accelerator(s) 1714 may include programmable vision accelerator (“PVA”), which may alternatively be referred to herein as a computer vision accelerator. In at least one embodiment, PVA may be designed and configured to accelerate computer vision algorithms for advanced driver assistance system (“ADAS”) 1738, autonomous driving, augmented reality (“AR”) applications, and/or virtual reality (“VR”) applications. In at least one embodiment, PVA may provide a balance between performance and flexibility. For example, in at least one embodiment, each PVA may include, for example and without limitation, any number of reduced instruction set computer (“RISC”) cores, direct memory access (“DMA”), and/or any number of vector processors.

In at least one embodiment, RISC cores may interact with image sensors (e.g., image sensors of any cameras described herein), image signal processor(s), etc. In at least one embodiment, each RISC core may include any amount of memory. In at least one embodiment, RISC cores may use any of a number of protocols, depending on embodiment. In at least one embodiment, RISC cores may execute a real-time operating system (“RTOS”). In at least one embodiment, RISC cores may be implemented using one or more integrated circuit devices, application specific integrated circuits (“ASICs”), and/or memory devices. For example, in at least one embodiment, RISC cores could include an instruction cache and/or a tightly coupled RAM.

In at least one embodiment, DMA may enable components of PVA to access system memory independently of CPU(s) 1706. In at least one embodiment, DMA may support any number of features used to provide optimization to a PVA including, but not limited to, supporting multi-dimensional addressing and/or circular addressing. In at least one embodiment, DMA may support up to six or more dimensions of addressing, which may include, without limitation, block width, block height, block depth, horizontal block stepping, vertical block stepping, and/or depth stepping.

In at least one embodiment, vector processors may be programmable processors that may be designed to efficiently and flexibly execute programming for computer vision algorithms and provide signal processing capabilities. In at least one embodiment, a PVA may include a PVA core and two vector processing subsystem partitions. In at least one embodiment, a PVA core may include a processor subsystem, DMA engine(s) (e.g., two DMA engines), and/or other peripherals. In at least one embodiment, a vector processing subsystem may operate as a primary processing engine of a PVA, and may include a vector processing unit (“VPU”), an instruction cache, and/or vector memory (e.g., “VMEM”). In at least one embodiment, VPU core may include a digital signal processor such as, for example, a single instruction, multiple data (“SIMD”), very long instruction word (“VLIW”) digital signal processor. In at least one embodiment, a combination of SIMD and VLIW may enhance throughput and speed.

In at least one embodiment, each of vector processors may include an instruction cache and may be coupled to dedicated memory. As a result, in at least one embodiment, each of vector processors may be configured to execute independently of other vector processors. In at least one embodiment, vector processors that are included in a particular PVA may be configured to employ data parallelism. For instance, in at least one embodiment, plurality of vector processors included in a single PVA may execute a common computer vision algorithm, but on different regions of an image. In at least one embodiment, vector processors included in a particular PVA may simultaneously execute different computer vision algorithms, on one image, or even execute different algorithms on sequential images or portions of an image. In at least one embodiment, among other things, any number of PVAs may be included in hardware acceleration cluster and any number of vector processors may be included in each PVA. In at least one embodiment, PVA may include additional error correcting code (“ECC”) memory, to enhance overall system safety.

In at least one embodiment, accelerator(s) 1714 may include a computer vision network on-chip and static random-access memory (“SRAM”), for providing a high-bandwidth, low latency SRAM for accelerator(s) 1714. In at least one embodiment, on-chip memory may include at least 4 MB SRAM, comprising, for example and without limitation, eight field-configurable memory blocks, that may be accessible by both a PVA and a DLA. In at least one embodiment, each pair of memory blocks may include an advanced peripheral bus (“APB”) interface, configuration circuitry, a controller, and a multiplexer. In at least one embodiment, any type of memory may be used. In at least one embodiment, a PVA and a DLA may access memory via a backbone that provides a PVA and a DLA with high-speed access to memory. In at least one embodiment, a backbone may include a computer vision network on-chip that interconnects a PVA and a DLA to memory (e.g., using APB).

In at least one embodiment, a computer vision network on-chip may include an interface that determines, before transmission of any control signal/address/data, that both a PVA and a DLA provide ready and valid signals. In at least one embodiment, an interface may provide for separate phases and separate channels for transmitting control signals/addresses/data, as well as burst-type communications for continuous data transfer. In at least one embodiment, an interface may comply with International Organization for Standardization (“ISO”) 26262 or International Electrotechnical Commission (“IEC”) 61508 standards, although other standards and protocols may be used.

In at least one embodiment, one or more of SoC(s) 1704 may include a real-time ray-tracing hardware accelerator. In at least one embodiment, real-time ray-tracing hardware accelerator may be used to quickly and efficiently determine positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses.

In at least one embodiment, accelerator(s) 1714 can have a wide array of uses for autonomous driving. In at least one embodiment, a PVA may be used for key processing stages in ADAS and autonomous vehicles. In at least one embodiment, a PVA's capabilities are a good match for algorithmic domains needing predictable processing, at low power and low latency. In other words, a PVA performs well on semi-dense or dense regular computation, even on small data sets, which might require predictable run-times with low latency and low power. In at least one embodiment, such as in vehicle 1700, PVAs might be designed to run classic computer vision algorithms, as they can be efficient at object detection and operating on integer math.

For example, according to at least one embodiment of technology, a PVA is used to perform computer stereo vision. In at least one embodiment, a semi-global matching-based algorithm may be used in some examples, although this is not intended to be limiting. In at least one embodiment, applications for Level 3-5 autonomous driving use motion estimation/stereo matching on-the-fly (e.g., structure from motion, pedestrian recognition, lane detection, etc.). In at least one embodiment, a PVA may perform computer stereo vision functions on inputs from two monocular cameras.

In at least one embodiment, a PVA may be used to perform dense optical flow. For example, in at least one embodiment, a PVA could process raw RADAR data (e.g., using a 4D Fast Fourier Transform) to provide processed RADAR data. In at least one embodiment, a PVA is used for time of flight depth processing, by processing raw time of flight data to provide processed time of flight data, for example.

In at least one embodiment, a DLA may be used to run any type of network to enhance control and driving safety, including for example and without limitation, a neural network that outputs a measure of confidence for each object detection. In at least one embodiment, confidence may be represented or interpreted as a probability, or as providing a relative “weight” of each detection compared to other detections. In at least one embodiment, a confidence measure enables a system to make further decisions regarding which detections should be considered as true positive detections rather than false positive detections. In at least one embodiment, a system may set a threshold value for confidence and consider only detections exceeding threshold value as true positive detections. In an embodiment in which an automatic emergency braking (“AEB”) system is used, false positive detections would cause vehicle to automatically perform emergency braking, which is obviously undesirable. In at least one embodiment, highly confident detections may be considered as triggers for AEB. In at least one embodiment, a DLA may run a neural network for regressing confidence value. In at least one embodiment, neural network may take as its input at least some subset of parameters, such as bounding box dimensions, ground plane estimate obtained (e.g., from another subsystem), output from IMU sensor(s) 1766 that correlates with vehicle 1700 orientation, distance, 3D location estimates of object obtained from neural network and/or other sensors (e.g., LIDAR sensor(s) 1764 or RADAR sensor(s) 1760), among others.

In at least one embodiment, one or more of SoC(s) 1704 may include data store(s) 1716 (e.g., memory). In at least one embodiment, data store(s) 1716 may be on-chip memory of SoC(s) 1704, which may store neural networks to be executed on GPU(s) 1708 and/or a DLA. In at least one embodiment, data store(s) 1716 may be large enough in capacity to store multiple instances of neural networks for redundancy and safety. In at least one embodiment, data store(s) 1716 may comprise L2 or L3 cache(s).

In at least one embodiment, one or more of SoC(s) 1704 may include any number of processor(s) 1710 (e.g., embedded processors). In at least one embodiment, processor(s) 1710 may include a boot and power management processor that may be a dedicated processor and subsystem to handle boot power and management functions and related security enforcement. In at least one embodiment, a boot and power management processor may be a part of a boot sequence of SoC(s) 1704 and may provide runtime power management services. In at least one embodiment, a boot power and management processor may provide clock and voltage programming, assistance in system low power state transitions, management of SoC(s) 1704 thermals and temperature sensors, and/or management of SoC(s) 1704 power states. In at least one embodiment, each temperature sensor may be implemented as a ring-oscillator whose output frequency is proportional to temperature, and SoC(s) 1704 may use ring-oscillators to detect temperatures of CPU(s) 1706, GPU(s) 1708, and/or accelerator(s) 1714. In at least one embodiment, if temperatures are determined to exceed a threshold, then a boot and power management processor may enter a temperature fault routine and put SoC(s) 1704 into a lower power state and/or put vehicle 1700 into a chauffeur to safe stop mode (e.g., bring vehicle 1700 to a safe stop).

In at least one embodiment, processor(s) 1710 may further include a set of embedded processors that may serve as an audio processing engine which may be an audio subsystem that enables full hardware support for multi-channel audio over multiple interfaces, and a broad and flexible range of audio I/O interfaces. In at least one embodiment, an audio processing engine is a dedicated processor core with a digital signal processor with dedicated RAM.

In at least one embodiment, processor(s) 1710 may further include an always-on processor engine that may provide necessary hardware features to support low power sensor management and wake use cases. In at least one embodiment, an always-on processor engine may include, without limitation, a processor core, a tightly coupled RAM, supporting peripherals (e.g., timers and interrupt controllers), various I/O controller peripherals, and routing logic.

In at least one embodiment, processor(s) 1710 may further include a safety cluster engine that includes, without limitation, a dedicated processor subsystem to handle safety management for automotive applications. In at least one embodiment, a safety cluster engine may include, without limitation, two or more processor cores, a tightly coupled RAM, support peripherals (e.g., timers, an interrupt controller, etc.), and/or routing logic. In a safety mode, two or more cores may operate, in at least one embodiment, in a lockstep mode and function as a single core with comparison logic to detect any differences between their operations. In at least one embodiment, processor(s) 1710 may further include a real-time camera engine that may include, without limitation, a dedicated processor subsystem for handling real-time camera management. In at least one embodiment, processor(s) 1710 may further include a high-dynamic range signal processor that may include, without limitation, an image signal processor that is a hardware engine that is part of a camera processing pipeline.

In at least one embodiment, processor(s) 1710 may include a video image compositor that may be a processing block (e.g., implemented on a microprocessor) that implements video post-processing functions needed by a video playback application to produce a final image for a player window. In at least one embodiment, a video image compositor may perform lens distortion correction on wide-view camera(s) 1770, surround camera(s) 1774, and/or on in-cabin monitoring camera sensor(s). In at least one embodiment, in-cabin monitoring camera sensor(s) are preferably monitored by a neural network running on another instance of SoC 1704, configured to identify in cabin events and respond accordingly. In at least one embodiment, an in-cabin system may perform, without limitation, lip reading to activate cellular service and place a phone call, dictate emails, change a vehicle's destination, activate or change a vehicle's infotainment system and settings, or provide voice-activated web surfing. In at least one embodiment, certain functions are available to a driver when a vehicle is operating in an autonomous mode and are disabled otherwise.

In at least one embodiment, a video image compositor may include enhanced temporal noise reduction for both spatial and temporal noise reduction. For example, in at least one embodiment, where motion occurs in a video, noise reduction weights spatial information appropriately, decreasing weights of information provided by adjacent frames. In at least one embodiment, where an image or portion of an image does not include motion, temporal noise reduction performed by video image compositor may use information from a previous image to reduce noise in a current image.

In at least one embodiment, a video image compositor may also be configured to perform stereo rectification on input stereo lens frames. In at least one embodiment, a video image compositor may further be used for user interface composition when an operating system desktop is in use, and GPU(s) 1708 are not required to continuously render new surfaces. In at least one embodiment, when GPU(s) 1708 are powered on and active doing 3D rendering, a video image compositor may be used to offload GPU(s) 1708 to improve performance and responsiveness.

In at least one embodiment, one or more SoC of SoC(s) 1704 may further include a mobile industry processor interface (“MIPI”) camera serial interface for receiving video and input from cameras, a high-speed interface, and/or a video input block that may be used for a camera and related pixel input functions. In at least one embodiment, one or more of SoC(s) 1704 may further include an input/output controller(s) that may be controlled by software and may be used for receiving I/O signals that are uncommitted to a specific role.

In at least one embodiment, one or more Soc of SoC(s) 1704 may further include a broad range of peripheral interfaces to enable communication with peripherals, audio encoders/decoders (“codecs”), power management, and/or other devices. In at least one embodiment, SoC(s) 1704 may be used to process data from cameras (e.g., connected over Gigabit Multimedia Serial Link and Ethernet channels), sensors (e.g., LIDAR sensor(s) 1764, RADAR sensor(s) 1760, etc. that may be connected over Ethernet channels), data from bus 1702 (e.g., speed of vehicle 1700, steering wheel position, etc.), data from GNSS sensor(s) 1758 (e.g., connected over a Ethernet bus or a CAN bus), etc. In at least one embodiment, one or more SoC of SoC(s) 1704 may further include dedicated high-performance mass storage controllers that may include their own DMA engines, and that may be used to free CPU(s) 1706 from routine data management tasks.

In at least one embodiment, SoC(s) 1704 may be an end-to-end platform with a flexible architecture that spans automation Levels 3-5, thereby providing a comprehensive functional safety architecture that leverages and makes efficient use of computer vision and ADAS techniques for diversity and redundancy, and provides a platform for a flexible, reliable driving software stack, along with deep learning tools. In at least one embodiment, SoC(s) 1704 may be faster, more reliable, and even more energy-efficient and space-efficient than conventional systems. For example, in at least one embodiment, accelerator(s) 1714, when combined with CPU(s) 1706, GPU(s) 1708, and data store(s) 1716, may provide for a fast, efficient platform for Level 3-5 autonomous vehicles.

In at least one embodiment, computer vision algorithms may be executed on CPUs, which may be configured using a high-level programming language, such as C, to execute a wide variety of processing algorithms across a wide variety of visual data. However, in at least one embodiment, CPUs are oftentimes unable to meet performance requirements of many computer vision applications, such as those related to execution time and power consumption, for example. In at least one embodiment, many CPUs are unable to execute complex object detection algorithms in real-time, which is used in in-vehicle ADAS applications and in practical Level 3-5 autonomous vehicles.

Embodiments described herein allow for multiple neural networks to be performed simultaneously and/or sequentially, and for results to be combined together to enable Level 3-5 autonomous driving functionality. For example, in at least one embodiment, a CNN executing on a DLA or a discrete GPU (e.g., GPU(s) 1720) may include text and word recognition, allowing reading and understanding of traffic signs, including signs for which a neural network has not been specifically trained. In at least one embodiment, a DLA may further include a neural network that is able to identify, interpret, and provide semantic understanding of a sign, and to pass that semantic understanding to path planning modules running on a CPU Complex.

In at least one embodiment, multiple neural networks may be run simultaneously, as for Level 3, 4, or 5 driving. For example, in at least one embodiment, a warning sign stating “Caution: flashing lights indicate icy conditions,” along with an electric light, may be independently or collectively interpreted by several neural networks. In at least one embodiment, such warning sign itself may be identified as a traffic sign by a first deployed neural network (e.g., a neural network that has been trained), text “flashing lights indicate icy conditions” may be interpreted by a second deployed neural network, which informs a vehicle's path planning software (preferably executing on a CPU Complex) that when flashing lights are detected, icy conditions exist. In at least one embodiment, a flashing light may be identified by operating a third deployed neural network over multiple frames, informing a vehicle's path-planning software of a presence (or an absence) of flashing lights. In at least one embodiment, all three neural networks may run simultaneously, such as within a DLA and/or on GPU(s) 1708.

In at least one embodiment, a CNN for facial recognition and vehicle owner identification may use data from camera sensors to identify presence of an authorized driver and/or owner of vehicle 1700. In at least one embodiment, an always-on sensor processing engine may be used to unlock a vehicle when an owner approaches a driver door and turns on lights, and, in a security mode, to disable such vehicle when an owner leaves such vehicle. In this way, SoC(s) 1704 provide for security against theft and/or carjacking.

In at least one embodiment, a CNN for emergency vehicle detection and identification may use data from microphones 1796 to detect and identify emergency vehicle sirens. In at least one embodiment, SoC(s) 1704 use a CNN for classifying environmental and urban sounds, as well as classifying visual data. In at least one embodiment, a CNN running on a DLA is trained to identify a relative closing speed of an emergency vehicle (e.g., by using a Doppler effect). In at least one embodiment, a CNN may also be trained to identify emergency vehicles specific to a local area in which a vehicle is operating, as identified by GNSS sensor(s) 1758. In at least one embodiment, when operating in Europe, a CNN will seek to detect European sirens, and when in North America, a CNN will seek to identify only North American sirens. In at least one embodiment, once an emergency vehicle is detected, a control program may be used to execute an emergency vehicle safety routine, slowing a vehicle, pulling over to a side of a road, parking a vehicle, and/or idling a vehicle, with assistance of ultrasonic sensor(s) 1762, until emergency vehicles pass.

In at least one embodiment, vehicle 1700 may include CPU(s) 1718 (e.g., discrete CPU(s), or dCPU(s)), that may be coupled to SoC(s) 1704 via a high-speed interconnect (e.g., PCIe). In at least one embodiment, CPU(s) 1718 may include an X86 processor, for example. CPU(s) 1718 may be used to perform any of a variety of functions, including arbitrating potentially inconsistent results between ADAS sensors and SoC(s) 1704, and/or monitoring status and health of controller(s) 1736 and/or an infotainment system on a chip (“infotainment SoC”) 1730, for example. In at least one embodiment, SoC(s) 1704 includes one or more interconnects, and an interconnect can include a peripheral component interconnect express (PCIe).

In at least one embodiment, vehicle 1700 may include GPU(s) 1720 (e.g., discrete GPU(s), or dGPU(s)), that may be coupled to SoC(s) 1704 via a high-speed interconnect (e.g., NVIDIA's NVLINK channel). In at least one embodiment, GPU(s) 1720 may provide additional artificial intelligence functionality, such as by executing redundant and/or different neural networks, and may be used to train and/or update neural networks based at least in part on input (e.g., sensor data) from sensors of a vehicle 1700.

In at least one embodiment, vehicle 1700 may further include network interface 1724 which may include, without limitation, wireless antenna(s) 1726 (e.g., one or more wireless antennas for different communication protocols, such as a cellular antenna, a Bluetooth antenna, etc.). In at least one embodiment, network interface 1724 may be used to enable wireless connectivity to Internet cloud services (e.g., with server(s) and/or other network devices), with other vehicles, and/or with computing devices (e.g., client devices of passengers). In at least one embodiment, to communicate with other vehicles, a direct link may be established between vehicle 170 and another vehicle and/or an indirect link may be established (e.g., across networks and over the Internet). In at least one embodiment, direct links may be provided using a vehicle-to-vehicle communication link. In at least one embodiment, a vehicle-to-vehicle communication link may provide vehicle 1700 information about vehicles in proximity to vehicle 1700 (e.g., vehicles in front of, on a side of, and/or behind vehicle 1700). In at least one embodiment, such aforementioned functionality may be part of a cooperative adaptive cruise control functionality of vehicle 1700.

In at least one embodiment, network interface 1724 may include an SoC that provides modulation and demodulation functionality and enables controller(s) 1736 to communicate over wireless networks. In at least one embodiment, network interface 1724 may include a radio frequency front-end for up-conversion from baseband to radio frequency, and down conversion from radio frequency to baseband. In at least one embodiment, frequency conversions may be performed in any technically feasible fashion. For example, frequency conversions could be performed through well-known processes, and/or using super-heterodyne processes. In at least one embodiment, radio frequency front end functionality may be provided by a separate chip. In at least one embodiment, network interfaces may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

In at least one embodiment, vehicle 1700 may further include data store(s) 1728 which may include, without limitation, off-chip (e.g., off SoC(s) 1704) storage. In at least one embodiment, data store(s) 1728 may include, without limitation, one or more storage elements including RAM, SRAM, dynamic random-access memory (“DRAM”), video random-access memory (“VRAM”), flash memory, hard disks, and/or other components and/or devices that may store at least one bit of data.

In at least one embodiment, vehicle 1700 may further include GNSS sensor(s) 1758 (e.g., GPS and/or assisted GPS sensors), to assist in mapping, perception, occupancy grid generation, and/or path planning functions. In at least one embodiment, any number of GNSS sensor(s) 1758 may be used, including, for example and without limitation, a GPS using a USB connector with an Ethernet-to-Serial (e.g., RS-232) bridge.

In at least one embodiment, vehicle 1700 may further include RADAR sensor(s) 1760. In at least one embodiment, RADAR sensor(s) 1760 may be used by vehicle 1700 for long-range vehicle detection, even in darkness and/or severe weather conditions. In at least one embodiment, RADAR functional safety levels may be ASIL B. In at least one embodiment, RADAR sensor(s) 1760 may use a CAN bus and/or bus 1702 (e.g., to transmit data generated by RADAR sensor(s) 1760) for control and to access object tracking data, with access to Ethernet channels to access raw data in some examples. In at least one embodiment, a wide variety of RADAR sensor types may be used. For example, and without limitation, RADAR sensor(s) 1760 may be suitable for front, rear, and side RADAR use. In at least one embodiment, one or more sensor of RADAR sensors(s) 1760 is a Pulse Doppler RADAR sensor.

In at least one embodiment, RADAR sensor(s) 1760 may include different configurations, such as long-range with narrow field of view, short-range with wide field of view, short-range side coverage, etc. In at least one embodiment, long-range RADAR may be used for adaptive cruise control functionality. In at least one embodiment, long-range RADAR systems may provide a broad field of view realized by two or more independent scans, such as within a 250 m (meter) range. In at least one embodiment, RADAR sensor(s) 1760 may help in distinguishing between static and moving objects, and may be used by ADAS system 1738 for emergency brake assist and forward collision warning. In at least one embodiment, sensors 1760(s) included in a long-range RADAR system may include, without limitation, monostatic multimodal RADAR with multiple (e.g., six or more) fixed RADAR antennae and a high-speed CAN and FlexRay interface. In at least one embodiment, with six antennae, a central four antennae may create a focused beam pattern, designed to record vehicle's 1700 surroundings at higher speeds with minimal interference from traffic in adjacent lanes. In at least one embodiment, another two antennae may expand field of view, making it possible to quickly detect vehicles entering or leaving a lane of vehicle 1700.

In at least one embodiment, mid-range RADAR systems may include, as an example, a range of up to 160 m (front) or 80 m (rear), and a field of view of up to 42 degrees (front) or 150 degrees (rear). In at least one embodiment, short-range RADAR systems may include, without limitation, any number of RADAR sensor(s) 1760 designed to be installed at both ends of a rear bumper. When installed at both ends of a rear bumper, in at least one embodiment, a RADAR sensor system may create two beams that constantly monitor blind spots in a rear direction and next to a vehicle. In at least one embodiment, short-range RADAR systems may be used in ADAS system 1738 for blind spot detection and/or lane change assist.

In at least one embodiment, vehicle 1700 may further include ultrasonic sensor(s) 1762. In at least one embodiment, ultrasonic sensor(s) 1762, which may be positioned at a front, a back, and/or side location of vehicle 1700, may be used for parking assist and/or to create and update an occupancy grid. In at least one embodiment, a wide variety of ultrasonic sensor(s) 1762 may be used, and different ultrasonic sensor(s) 1762 may be used for different ranges of detection (e.g., 2.5 m, 4 m). In at least one embodiment, ultrasonic sensor(s) 1762 may operate at functional safety levels of ASIL B.

In at least one embodiment, vehicle 1700 may include LIDAR sensor(s) 1764. In at least one embodiment, LIDAR sensor(s) 1764 may be used for object and pedestrian detection, emergency braking, collision avoidance, and/or other functions. In at least one embodiment, LIDAR sensor(s) 1764 may operate at functional safety level ASIL B. In at least one embodiment, vehicle 1700 may include multiple LIDAR sensors 1764 (e.g., two, four, six, etc.) that may use an Ethernet channel (e.g., to provide data to a Gigabit Ethernet switch).

In at least one embodiment, LIDAR sensor(s) 1764 may be capable of providing a list of objects and their distances for a 360-degree field of view. In at least one embodiment, commercially available LIDAR sensor(s) 1764 may have an advertised range of approximately 100 m, with an accuracy of 2 cm to 3 cm, and with support for a 100 Mbps Ethernet connection, for example. In at least one embodiment, one or more non-protruding LIDAR sensors may be used. In such an embodiment, LIDAR sensor(s) 1764 may include a small device that may be embedded into a front, a rear, a side, and/or a corner location of vehicle 1700. In at least one embodiment, LIDAR sensor(s) 1764, in such an embodiment, may provide up to a 120-degree horizontal and 35-degree vertical field-of-view, with a 200 m range even for low-reflectivity objects. In at least one embodiment, front-mounted LIDAR sensor(s) 1764 may be configured for a horizontal field of view between 45 degrees and 135 degrees.

In at least one embodiment, LIDAR technologies, such as 3D flash LIDAR, may also be used. In at least one embodiment, 3D flash LIDAR uses a flash of a laser as a transmission source, to illuminate surroundings of vehicle 1700 up to approximately 200 m. In at least one embodiment, a flash LIDAR unit includes, without limitation, a receptor, which records laser pulse transit time and reflected light on each pixel, which in turn corresponds to a range from vehicle 1700 to objects. In at least one embodiment, flash LIDAR may allow for highly accurate and distortion-free images of surroundings to be generated with every laser flash. In at least one embodiment, four flash LIDAR sensors may be deployed, one at each side of vehicle 1700. In at least one embodiment, 3D flash LIDAR systems include, without limitation, a solid-state 3D staring array LIDAR camera with no moving parts other than a fan (e.g., a non-scanning LIDAR device). In at least one embodiment, flash LIDAR device may use a 5 nanosecond class I (eye-safe) laser pulse per frame and may capture reflected laser light as a 3D range point cloud and co-registered intensity data.

In at least one embodiment, vehicle 1700 may further include IMU sensor(s) 1766. In at least one embodiment, IMU sensor(s) 1766 may be located at a center of a rear axle of vehicle 1700. In at least one embodiment, IMU sensor(s) 1766 may include, for example and without limitation, accelerometer(s), magnetometer(s), gyroscope(s), a magnetic compass, magnetic compasses, and/or other sensor types. In at least one embodiment, such as in six-axis applications, IMU sensor(s) 1766 may include, without limitation, accelerometers and gyroscopes. In at least one embodiment, such as in nine-axis applications, IMU sensor(s) 1766 may include, without limitation, accelerometers, gyroscopes, and magnetometers.

In at least one embodiment, IMU sensor(s) 1766 may be implemented as a miniature, high performance GPS-Aided Inertial Navigation System (“GPS/INS”) that combines micro-electro-mechanical systems (“MEMS”) inertial sensors, a high-sensitivity GPS receiver, and advanced Kalman filtering algorithms to provide estimates of position, velocity, and attitude. In at least one embodiment, IMU sensor(s) 1766 may enable vehicle 1700 to estimate its heading without requiring input from a magnetic sensor by directly observing and correlating changes in velocity from a GPS to IMU sensor(s) 1766. In at least one embodiment, IMU sensor(s) 1766 and GNSS sensor(s) 1758 may be combined in a single integrated unit.

In at least one embodiment, vehicle 1700 may include microphone(s) 1796 placed in and/or around vehicle 1700. In at least one embodiment, microphone(s) 1796 may be used for emergency vehicle detection and identification, among other things.

In at least one embodiment, vehicle 1700 may further include any number of camera types, including stereo camera(s) 1768, wide-view camera(s) 1770, infrared camera(s) 1772, surround camera(s) 1774, long-range camera(s) 1798, mid-range camera(s) 1776, and/or other camera types. In at least one embodiment, cameras may be used to capture image data around an entire periphery of vehicle 1700. In at least one embodiment, which types of cameras used depends on vehicle 1700. In at least one embodiment, any combination of camera types may be used to provide necessary coverage around vehicle 1700. In at least one embodiment, a number of cameras deployed may differ depending on embodiment. For example, in at least one embodiment, vehicle 1700 could include six cameras, seven cameras, ten cameras, twelve cameras, or another number of cameras. In at least one embodiment, cameras may support, as an example and without limitation, Gigabit Multimedia Serial Link (“GMSL”) and/or Gigabit Ethernet communications. In at least one embodiment, each camera might be as described with more detail previously herein with respect to FIG. 17A and FIG. 17B.

In at least one embodiment, vehicle 1700 may further include vibration sensor(s) 1742. In at least one embodiment, vibration sensor(s) 1742 may measure vibrations of components of vehicle 1700, such as axle(s). For example, in at least one embodiment, changes in vibrations may indicate a change in road surfaces. In at least one embodiment, when two or more vibration sensors 1742 are used, differences between vibrations may be used to determine friction or slippage of road surface (e.g., when a difference in vibration is between a power-driven axle and a freely rotating axle).

In at least one embodiment, vehicle 1700 may include ADAS system 1738. In at least one embodiment, ADAS system 1738 may include, without limitation, an SoC, in some examples. In at least one embodiment, ADAS system 1738 may include, without limitation, any number and combination of an autonomous/adaptive/automatic cruise control (“ACC”) system, a cooperative adaptive cruise control (“CACC”) system, a forward crash warning (“FCW”) system, an automatic emergency braking (“AEB”) system, a lane departure warning (“LDW)” system, a lane keep assist (“LKA”) system, a blind spot warning (“BSW”) system, a rear cross-traffic warning (“RCTW”) system, a collision warning (“CW”) system, a lane centering (“LC”) system, and/or other systems, features, and/or functionality.

In at least one embodiment, ACC system may use RADAR sensor(s) 1760, LIDAR sensor(s) 1764, and/or any number of camera(s). In at least one embodiment, ACC system may include a longitudinal ACC system and/or a lateral ACC system. In at least one embodiment, a longitudinal ACC system monitors and controls distance to another vehicle immediately ahead of vehicle 1700 and automatically adjusts speed of vehicle 1700 to maintain a safe distance from vehicles ahead. In at least one embodiment, a lateral ACC system performs distance keeping, and advises vehicle 1700 to change lanes when necessary. In at least one embodiment, a lateral ACC is related to other ADAS applications, such as LC and CW.

In at least one embodiment, a CACC system uses information from other vehicles that may be received via network interface 1724 and/or wireless antenna(s) 1726 from other vehicles via a wireless link, or indirectly, over a network connection (e.g., over the Internet). In at least one embodiment, direct links may be provided by a vehicle-to-vehicle (“V2V”) communication link, while indirect links may be provided by an infrastructure-to-vehicle (“I2V”) communication link. In general, V2V communication provides information about immediately preceding vehicles (e.g., vehicles immediately ahead of and in same lane as vehicle 1700), while I2V communication provides information about traffic further ahead. In at least one embodiment, a CACC system may include either or both I2V and V2V information sources. In at least one embodiment, given information of vehicles ahead of vehicle 1700, a CACC system may be more reliable and it has potential to improve traffic flow smoothness and reduce congestion on road.

In at least one embodiment, an FCW system is designed to alert a driver to a hazard, so that such driver may take corrective action. In at least one embodiment, an FCW system uses a front-facing camera and/or RADAR sensor(s) 1760, coupled to a dedicated processor, DSP, FPGA, and/or ASIC, that is electrically coupled to provide driver feedback, such as a display, speaker, and/or vibrating component. In at least one embodiment, an FCW system may provide a warning, such as in form of a sound, visual warning, vibration and/or a quick brake pulse.

In at least one embodiment, an AEB system detects an impending forward collision with another vehicle or other object, and may automatically apply brakes if a driver does not take corrective action within a specified time or distance parameter. In at least one embodiment, AEB system may use front-facing camera(s) and/or RADAR sensor(s) 1760, coupled to a dedicated processor, DSP, FPGA, and/or ASIC. In at least one embodiment, when an AEB system detects a hazard, it will typically first alert a driver to take corrective action to avoid collision and, if that driver does not take corrective action, that AEB system may automatically apply brakes in an effort to prevent, or at least mitigate, an impact of a predicted collision. In at least one embodiment, an AEB system may include techniques such as dynamic brake support and/or crash imminent braking.

In at least one embodiment, an LDW system provides visual, audible, and/or tactile warnings, such as steering wheel or seat vibrations, to alert driver when vehicle 1700 crosses lane markings. In at least one embodiment, an LDW system does not activate when a driver indicates an intentional lane departure, such as by activating a turn signal. In at least one embodiment, an LDW system may use front-side facing cameras, coupled to a dedicated processor, DSP, FPGA, and/or ASIC, that is electrically coupled to provide driver feedback, such as a display, speaker, and/or vibrating component. In at least one embodiment, an LKA system is a variation of an LDW system. In at least one embodiment, an LKA system provides steering input or braking to correct vehicle 1700 if vehicle 1700 starts to exit its lane.

In at least one embodiment, a BSW system detects and warns a driver of vehicles in an automobile's blind spot. In at least one embodiment, a BSW system may provide a visual, audible, and/or tactile alert to indicate that merging or changing lanes is unsafe. In at least one embodiment, a BSW system may provide an additional warning when a driver uses a turn signal. In at least one embodiment, a BSW system may use rear-side facing camera(s) and/or RADAR sensor(s) 1760, coupled to a dedicated processor, DSP, FPGA, and/or ASIC, that is electrically coupled to driver feedback, such as a display, speaker, and/or vibrating component.

In at least one embodiment, an RCTW system may provide visual, audible, and/or tactile notification when an object is detected outside a rear-camera range when vehicle 1700 is backing up. In at least one embodiment, an RCTW system includes an AEB system to ensure that vehicle brakes are applied to avoid a crash. In at least one embodiment, an RCTW system may use one or more rear-facing RADAR sensor(s) 1760, coupled to a dedicated processor, DSP, FPGA, and/or ASIC, that is electrically coupled to provide driver feedback, such as a display, speaker, and/or vibrating component.

In at least one embodiment, conventional ADAS systems may be prone to false positive results which may be annoying and distracting to a driver, but typically are not catastrophic, because conventional ADAS systems alert a driver and allow that driver to decide whether a safety condition truly exists and act accordingly. In at least one embodiment, vehicle 1700 itself decides, in case of conflicting results, whether to heed result from a primary computer or a secondary computer (e.g., a first controller or a second controller of controllers 1736). For example, in at least one embodiment, ADAS system 1738 may be a backup and/or secondary computer for providing perception information to a backup computer rationality module. In at least one embodiment, a backup computer rationality monitor may run redundant diverse software on hardware components to detect faults in perception and dynamic driving tasks. In at least one embodiment, outputs from ADAS system 1738 may be provided to a supervisory MCU. In at least one embodiment, if outputs from a primary computer and outputs from a secondary computer conflict, a supervisory MCU determines how to reconcile conflict to ensure safe operation.

In at least one embodiment, a primary computer may be configured to provide a supervisory MCU with a confidence score, indicating that primary computer's confidence in a chosen result. In at least one embodiment, if that confidence score exceeds a threshold, that supervisory MCU may follow that primary computer's direction, regardless of whether that secondary computer provides a conflicting or inconsistent result. In at least one embodiment, where a confidence score does not meet a threshold, and where primary and secondary computers indicate different results (e.g., a conflict), a supervisory MCU may arbitrate between computers to determine an appropriate outcome.

In at least one embodiment, a supervisory MCU may be configured to run a neural network(s) that is trained and configured to determine, based at least in part on outputs from a primary computer and outputs from a secondary computer, conditions under which that secondary computer provides false alarms. In at least one embodiment, neural network(s) in a supervisory MCU may learn when a secondary computer's output may be trusted, and when it cannot. For example, in at least one embodiment, when that secondary computer is a RADAR-based FCW system, a neural network(s) in that supervisory MCU may learn when an FCW system is identifying metallic objects that are not, in fact, hazards, such as a drainage grate or manhole cover that triggers an alarm. In at least one embodiment, when a secondary computer is a camera-based LDW system, a neural network in a supervisory MCU may learn to override LDW when bicyclists or pedestrians are present and a lane departure is, in fact, a safest maneuver. In at least one embodiment, a supervisory MCU may include at least one of a DLA or a GPU suitable for running neural network(s) with associated memory. In at least one embodiment, a supervisory MCU may comprise and/or be included as a component of SoC(s) 1704.

In at least one embodiment, ADAS system 1738 may include a secondary computer that performs ADAS functionality using traditional rules of computer vision. In at least one embodiment, that secondary computer may use classic computer vision rules (if-then), and presence of a neural network(s) in a supervisory MCU may improve reliability, safety and performance. For example, in at least one embodiment, diverse implementation and intentional non-identity makes an overall system more fault-tolerant, especially to faults caused by software (or software-hardware interface) functionality. For example, in at least one embodiment, if there is a software bug or error in software running on a primary computer, and non-identical software code running on a secondary computer provides a consistent overall result, then a supervisory MCU may have greater confidence that an overall result is correct, and a bug in software or hardware on that primary computer is not causing a material error.

In at least one embodiment, an output of ADAS system 1738 may be fed into a primary computer's perception block and/or a primary computer's dynamic driving task block. For example, in at least one embodiment, if ADAS system 1738 indicates a forward crash warning due to an object immediately ahead, a perception block may use this information when identifying objects. In at least one embodiment, a secondary computer may have its own neural network that is trained and thus reduces a risk of false positives, as described herein.

In at least one embodiment, vehicle 1700 may further include infotainment SoC 1730 (e.g., an in-vehicle infotainment system (IVI)). Although illustrated and described as an SoC, infotainment system SoC 1730, in at least one embodiment, may not be an SoC, and may include, without limitation, two or more discrete components. In at least one embodiment, infotainment SoC 1730 may include, without limitation, a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, WiFi, etc.), and/or information services (e.g., navigation systems, rear-parking assistance, a radio data system, vehicle related information such as fuel level, total distance covered, brake fuel level, oil level, door open/close, air filter information, etc.) to vehicle 1700. For example, infotainment SoC 1730 could include radios, disk players, navigation systems, video players, USB and Bluetooth connectivity, carputers, in-car entertainment, WiFi, steering wheel audio controls, hands free voice control, a heads-up display (“HUD”), HMI display 1734, a telematics device, a control panel (e.g., for controlling and/or interacting with various components, features, and/or systems), and/or other components. In at least one embodiment, infotainment SoC 1730 may further be used to provide information (e.g., visual and/or audible) to user(s) of vehicle 1700, such as information from ADAS system 1738, autonomous driving information such as planned vehicle maneuvers, trajectories, surrounding environment information (e.g., intersection information, vehicle information, road information, etc.), and/or other information.

In at least one embodiment, infotainment SoC 1730 may include any amount and type of GPU functionality. In at least one embodiment, infotainment SoC 1730 may communicate over bus 1702 with other devices, systems, and/or components of vehicle 1700. In at least one embodiment, infotainment SoC 1730 may be coupled to a supervisory MCU such that a GPU of an infotainment system may perform some self-driving functions in event that primary controller(s) 1736 (e.g., primary and/or backup computers of vehicle 1700) fail. In at least one embodiment, infotainment SoC 1730 may put vehicle 1700 into a chauffeur to safe stop mode, as described herein.

In at least one embodiment, vehicle 1700 may further include instrument cluster 1732 (e.g., a digital dash, an electronic instrument cluster, a digital instrument panel, etc.). In at least one embodiment, instrument cluster 1732 may include, without limitation, a controller and/or supercomputer (e.g., a discrete controller or supercomputer). In at least one embodiment, instrument cluster 1732 may include, without limitation, any number and combination of a set of instrumentation such as a speedometer, fuel level, oil pressure, tachometer, odometer, turn indicators, gearshift position indicator, seat belt warning light(s), parking-brake warning light(s), engine-malfunction light(s), supplemental restraint system (e.g., airbag) information, lighting controls, safety system controls, navigation information, etc. In some examples, information may be displayed and/or shared among infotainment SoC 1730 and instrument cluster 1732. In at least one embodiment, instrument cluster 1732 may be included as part of infotainment SoC 1730, or vice versa.

Such components can be used to generate an alternate view image, such as a bird's eye view image, from disparity data using limited capacity hardware, such as an embedded processor without access to external memory.

FIG. 17D is a diagram of a system for communication between cloud-based server(s) and autonomous vehicle 1700 of FIG. 17A, according to at least one embodiment. In at least one embodiment, system may include, without limitation, server(s) 1778, network(s) 1790, and any number and type of vehicles, including vehicle 1700. In at least one embodiment, server(s) 1778 may include, without limitation, a plurality of GPUs 1784(A)-1784(H) (collectively referred to herein as GPUs 1784), PCIe switches 1782(A)-1782(D) (collectively referred to herein as PCIe switches 1782), and/or CPUs 1780(A)-1780(B) (collectively referred to herein as CPUs 1780). In at least one embodiment, GPUs 1784, CPUs 1780, and PCIe switches 1782 may be interconnected with high-speed interconnects such as, for example and without limitation, NVLink interfaces 1788 developed by NVIDIA and/or PCIe connections 1786. In at least one embodiment, GPUs 1784 are connected via an NVLink and/or NVSwitch SoC and GPUs 1784 and PCIe switches 1782 are connected via PCIe interconnects. Although eight GPUs 1784, two CPUs 1780, and four PCIe switches 1782 are illustrated, this is not intended to be limiting. In at least one embodiment, each of server(s) 1778 may include, without limitation, any number of GPUs 1784, CPUs 1780, and/or PCIe switches 1782, in any combination. For example, in at least one embodiment, server(s) 1778 could each include eight, sixteen, thirty-two, and/or more GPUs 1784.

In at least one embodiment, server(s) 1778 may receive, over network(s) 1790 and from vehicles, image data representative of images showing unexpected or changed road conditions, such as recently commenced road-work. In at least one embodiment, server(s) 1778 may transmit, over network(s) 1790 and to vehicles, neural networks 1792, updated or otherwise, and/or map information 1794, including, without limitation, information regarding traffic and road conditions. In at least one embodiment, updates to map information 1794 may include, without limitation, updates for HD map 1722, such as information regarding construction sites, potholes, detours, flooding, and/or other obstructions. In at least one embodiment, neural networks 1792, and/or map information 1794 may have resulted from new training and/or experiences represented in data received from any number of vehicles in an environment, and/or based at least in part on training performed at a data center (e.g., using server(s) 1778 and/or other servers).

In at least one embodiment, server(s) 1778 may be used to train machine learning models (e.g., neural networks) based at least in part on training data. In at least one embodiment, training data may be generated by vehicles, and/or may be generated in a simulation (e.g., using a game engine). In at least one embodiment, any amount of training data is tagged (e.g., where associated neural network benefits from supervised learning) and/or undergoes other pre-processing. In at least one embodiment, any amount of training data is not tagged and/or pre-processed (e.g., where associated neural network does not require supervised learning). In at least one embodiment, once machine learning models are trained, machine learning models may be used by vehicles (e.g., transmitted to vehicles over network(s) 1790), and/or machine learning models may be used by server(s) 1778 to remotely monitor vehicles.

In at least one embodiment, server(s) 1778 may receive data from vehicles and apply data to up-to-date real-time neural networks for real-time intelligent inferencing. In at least one embodiment, server(s) 1778 may include deep-learning supercomputers and/or dedicated AI computers powered by GPU(s) 1784, such as a DGX and DGX Station machines developed by NVIDIA. However, in at least one embodiment, server(s) 1778 may include deep learning infrastructure that uses CPU-powered data centers.

In at least one embodiment, deep-learning infrastructure of server(s) 1778 may be capable of fast, real-time inferencing, and may use that capability to evaluate and verify health of processors, software, and/or associated hardware in vehicle 1700. For example, in at least one embodiment, deep-learning infrastructure may receive periodic updates from vehicle 1700, such as a sequence of images and/or objects that vehicle 1700 has located in that sequence of images (e.g., via computer vision and/or other machine learning object classification techniques). In at least one embodiment, deep-learning infrastructure may run its own neural network to identify objects and compare them with objects identified by vehicle 1700 and, if results do not match and deep-learning infrastructure concludes that AI in vehicle 1700 is malfunctioning, then server(s) 1778 may transmit a signal to vehicle 1700 instructing a fail-safe computer of vehicle 1700 to assume control, notify passengers, and complete a safe parking maneuver.

Such components can be used to generate an alternate view image, such as a bird's eye view image, from disparity data using limited capacity hardware, such as an embedded processor without access to external memory.

Various embodiments can be described by the following clauses:
1. A system, comprising:
at least one embedded processor with direct memory access (DMA) functionality to:
   generate a two-dimensional (2D) histogram view of one or more objects in an environment based in part on disparity data for the one or more objects, the two-dimensional histogram view being a function of angle and distance to a plane of at least one camera used to generate the stereo disparity data; and
   generate a bird's eye view image of the one or more objects by transforming the 2D histogram view.
2. The system of clause 1, wherein the at least one embedded processor lacks access to external memory to use in generating the bird's eye view image.
3. The system of clause 1, wherein the system is further to determine the disparity data using image data captured using the camera.
4. The system of clause 1, wherein the camera is a stereoscopic camera assembly or a pair of matched camera sensors.
5. The system of clause 1, wherein the bird's eye view image is generated in part by generating a list of object centroids and statistics using the 2D histogram view and transforming the list into a corresponding list in a coordinate system of the bird's eye view.
6. The system of clause 1, wherein data transfers for the embedded processor are performed using the DMA on rectangular regions of image data.
7. The system of clause 1, wherein the at least one embedded processor is further to:
receive stereoscopic image data from the at least one camera; and
generate, using the stereoscopic image data, a disparity map including the disparity data for the one or more objects.
8. The system of clause 1, wherein the disparity data includes data obtained from at least one additional sensor.
9. The system of clause 1, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM),
a system for performing generative AI operations using a vision language model (VLM),
a system for performing generative AI operations using a multi-modal language model (MMLM);
a system for deploying one or more language models using an operating system (OS)-level virtualization container that communicates with the one or more language models using one or more application programming interfaces (APIs);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.
10. At least one embedded processor, with direct memory access (DMA) functionality, to generate a bird's eye view image for a scene by generating, from disparity data for the scene, an intermediate histogram as a function of angle and distance to a camera plane, and transforming the intermediate histogram to the bird's eye view image.
11. The at least one embedded processor of clause 10, wherein the intermediate histogram includes representations of one or more objects in the scene, and wherein the at least one embedded processor is further to perform a connected components analysis on the intermediate histogram to identify pixel locations associated with the one or more objects.
12. The at least one embedded processor of clause 11, wherein the at least one embedded processor is further to generate a list of object centroids and statistics for the one or more objects using the intermediate histogram view, and transform the list into a corresponding list in a coordinate system of the bird's eye view image.
13. The at least one embedded processor of clause 10, wherein the at least one embedded processor lacks access to a full set of image data stored in external memory to use in generating the intermediate histogram or the bird's eye view image.
14. The at least one embedded processor of clause 10, wherein data transfers for the at least one embedded processor are performed using the DMA on rectangular regions of image data.
15. The at least one embedded processor of clause 10, wherein the at least one embedded processor is further to determine the disparity data using image data captured using at least a stereoscopic camera assembly.
16. The at least one embedded processor of clause 10, wherein the at least one embedded processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM),
a system for performing generative AI operations using a vision language model (VLM),
a system for performing generative AI operations using a multi-modal language model (MMLM);
a system for deploying one or more language models using an operating system (OS)-level virtualization container that communicates with the one or more language models using one or more application programming interfaces (APIs);
a collaborative content creation platform for 3D assets; or
a system implemented at least partially using cloud computing resources.
17. A computer-implemented method, comprising:
generating, using an embedded processor with DMA memory access, an intermediate histogram representation of a disparity image;
identifying locations in the intermediate histogram representation associated with one or more objects; and
transforming, using the embedded processor and based in part upon the locations, the intermediate histogram representation into a bird's eye view image including representations of the one or more objects.
18. The computer-implemented method of clause 17, wherein the embedded processor lacks access to external memory to use in generating the intermediate histogram representation or the bird's eye view image.
19. The computer-implemented method of clause 17, further comprising:
performing, using the embedded processor, a connected components analysis on the intermediate histogram representation to identify the locations associated with the one or more objects.
20. The computer-implemented method of clause 18, further comprising:
generating, using the embedded processor, a list of object centroids and statistics for the one or more objects from the intermediate histogram representation; and
transforming, using the embedded processor, the list into a corresponding list in a coordinate system of the bird's eye view image.
21. The computer-implemented method of clause 18, wherein the bird's eye view image is provided for use in a simulation of the one or more objects generated, at least in part, using a three-dimensional (3D) content collaboration platform for 3D assets.
22. The computer-implemented method of claim 21, wherein the 3D content collaboration platform for 3D assets uses OpenUSD.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
at least one embedded processor with direct memory access (DMA) functionality to:
generate a two-dimensional (2D) histogram view of one or more objects in an environment based in part on disparity data for the one or more objects, the two-dimensional histogram view being a function of angle and distance to a plane of at least one camera used to generate the stereo disparity data; and
generate a bird's eye view image of the one or more objects by transforming the 2D histogram view.

2. The system of claim 1, wherein the at least one embedded processor lacks access to external memory to use in generating the bird's eye view image.

3. The system of claim 1, wherein the system is further to determine the disparity data using image data captured using the camera.

4. The system of claim 1, wherein the camera is a stereoscopic camera assembly or a pair of matched camera sensors.

5. The system of claim 1, wherein the bird's eye view image is generated in part by generating a list of object centroids and statistics using the 2D histogram view and transforming the list into a corresponding list in a coordinate system of the bird's eye view.

6. The system of claim 1, wherein data transfers for the embedded processor are performed using the DMA on rectangular regions of image data.

7. The system of claim 1, wherein the at least one embedded processor is further to:
receive stereoscopic image data from the at least one camera; and
generate, using the stereoscopic image data, a disparity map including the disparity data for the one or more objects.

8. The system of claim 1, wherein the disparity data includes data obtained from at least one additional sensor.

9. The system of claim 1, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM),
a system for performing generative AI operations using a vision language model (VLM),
a system for performing generative AI operations using a multi-modal language model (MMLM);
a system for deploying one or more language models using an operating system (OS)-level virtualization container that communicates with the one or more language models using one or more application programming interfaces (APIs);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.

10. At least one embedded processor, with direct memory access (DMA) functionality, to generate a bird's eye view image for a scene by generating, from disparity data for the scene, an intermediate histogram as a function of angle and distance to a camera plane, and transforming the intermediate histogram to the bird's eye view image.

11. The at least one embedded processor of claim 10, wherein the intermediate histogram includes representations of one or more objects in the scene, and wherein the at least one embedded processor is further to perform a connected components analysis on the intermediate histogram to identify pixel locations associated with the one or more objects.

12. The at least one embedded processor of claim 11, wherein the at least one embedded processor is further to generate a list of object centroids and statistics for the one or more objects using the intermediate histogram view, and transform the list into a corresponding list in a coordinate system of the bird's eye view image.

13. The at least one embedded processor of claim 10, wherein the at least one embedded processor lacks access to a full set of image data stored in external memory to use in generating the intermediate histogram or the bird's eye view image.

14. The at least one embedded processor of claim 10, wherein data transfers for the at least one embedded processor are performed using the DMA on rectangular regions of image data.

15. The at least one embedded processor of claim 10, wherein the at least one embedded processor is further to determine the disparity data using image data captured using at least a stereoscopic camera assembly.

16. The at least one embedded processor of claim 10, wherein the at least one embedded processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM),
a system for performing generative AI operations using a vision language model (VLM),
a system for performing generative AI operations using a multi-modal language model (MMLM);
a system for deploying one or more language models using an operating system (OS)-level virtualization container that communicates with the one or more language models using one or more application programming interfaces (APIs);
a collaborative content creation platform for 3D assets; or
a system implemented at least partially using cloud computing resources.

17. A computer-implemented method, comprising:
generating, using an embedded processor with DMA memory access, an intermediate histogram representation of a disparity image;
identifying locations in the intermediate histogram representation associated with one or more objects; and
transforming, using the embedded processor and based in part upon the locations, the intermediate histogram representation into a bird's eye view image including representations of the one or more objects.

18. The computer-implemented method of claim 17, wherein the embedded processor lacks access to external memory to use in generating the intermediate histogram representation or the bird's eye view image.

19. The computer-implemented method of claim 17, further comprising:
performing, using the embedded processor, a connected components analysis on the intermediate histogram representation to identify the locations associated with the one or more objects.

20. The computer-implemented method of claim 18, further comprising:
generating, using the embedded processor, a list of object centroids and statistics for the one or more objects from the intermediate histogram representation; and
transforming, using the embedded processor, the list into a corresponding list in a coordinate system of the bird's eye view image.

21. The computer-implemented method of claim 18, wherein the bird's eye view image is provided for use in a simulation of the one or more objects generated, at least in part, using a three-dimensional (3D) content collaboration platform for 3D assets.

22. The computer-implemented method of claim 21, wherein the 3D content collaboration platform for 3D assets uses OpenUSD.
